(19) United States
(12) Patent Application Publication
(10) Pub. No.: US 2026/0078882 A1
(43) Pub. Date: Mar. 19, 2026

(54) DELTA LUMINAIRE - PHOTOVOLTAIC POWERED ROADWAY & AREA LIGHTING LUMINAIRE

(71) Applicant: Exposure Illumination Architects, Inc., Scottsdale, AZ (US)

(72) Inventor: Daniel S. SPIRO, Scottsdale, AZ (US)

(73) Assignee: Exposure Illumination Architects, Inc., Scottsdale, AZ (US)

(21) Appl. No.: 19/384,562

(22) Filed: Nov. 10, 2025

Related U.S. Application Data
(63) Continuation-in-part of application No. 18/227,360, filed on Jul. 28, 2023, now Pat. No. 12,492,788.
(60) Provisional application No. 63/524,432, filed on Jun. 30, 2023.

(51) Int. Cl. F21S 9/03; F21V 15/00; F21V 17/00; F21V 17/10; F21V 23/00; F21V 23/02; F21V 23/04; F21V 33/00; G08B 3/10

(52) U.S. Cl. CPC F21S 9/035; F21V 15/005; F21V 17/005; F21V 17/107; F21V 23/002; F21V 23/02; F21V 23/0435; F21V 23/0478; F21V 33/0056; G08B 3/10

(57) ABSTRACT

A slimline modular inverter pod coupled to a vertical structure configured to operate unitarily or in unison with other inverter pods coupled to the same vertical structure, wherein power received by the inverter pod is generated by PV panel/s coupled to the vertical structure above, and long-lived power consuming/generating devices are coupled to and/or in proximity to the vertical structure's top and at least one short-lived power consuming device is coupled to the vertical structure assembly at two thirds the vertical structure height from grade or lower.

### CROSS-REFERENCE TO RELATED APPLICATION

The present application is a continuation in part of US patent application Ser. No. 18/227,360, filed Jul. 23, 2023, and also claims the benefit of the earlier filing date of U.S. provisional application 63/524,432, filed Jun. 30, 2023, the entire contents of both of which being incorporated herein by reference.

### BACKGROUND

### TECHNICAL FIELD

The present disclosure relates to a self-powered roadway luminaire using photovoltaics (PV).

### DISCUSSION OF BACKGROUND

The following description of the BACKGROUND includes new observations and insights made by the present inventor regarding the state of the art in area lighting luminaires, and thus these observations and insights should not be construed as admitted prior art.

Roadway and area lighting luminaires are commonly coupled to poles (i.e., vertical structures that are able to host another component, such as a luminaire, at an elevated height).

Within the urban fabric, roadway and area lighting poles are spaced apart from one another, with the luminaires providing the illumination light levels in accordance with the design intent. The lighting designer configures the needed lighting parameters by assessing the pole location, height, pole spacing, available luminaire type, the light level, and the uniformity ratio/s mandated. In municipal, county, state and federal right of ways, the specifications are mandated by a governing entity.

LED (Light Emitting Diode) is the current lighting industry choice for roadway and area lighting luminaires. A pole mounted LED luminaire, with its power supply driving the luminaire's light source (the driver), consumes electrical power. The power can be delivered by tapping into an urban power provider grid and/or can be locally generated by a power generating device coupled to a pole and/or installed in the vicinity of the pole. Presently, locally generated photovoltaic (PV) power is becoming increasingly affordable.

The PV technology harnesses the sun's electromagnetic photonic radiation and converts the energy to electrical power. The technology's key elements include: the PV panels, the power converter, and the power storage that stores the generated power until it is needed. The electricity generated can be stored, transmitted to a power consuming device, and/or conveyed to a remote power grid. To optimize power usage, it is a common practice to transmit daytime generated PV power to a remote user/s through the grid and at nighttime, when cost of power is lower, to return at least a part of the power transmitted to the pole mounted luminaire/s. (In the present document the convention “xxx/s” is shorthand notation for “one or more” and thus should be construed as singular or plural).

The PV panel/s of a self-power generating light pole is configured to collect solar energy from the sun, convert the solar energy into electricity, and use the electricity to provide electrical power to a LED light source that illuminates a surface area below at night. To capture maximum sun energy, the PV panel/s is typically tilted toward an optimal sun orbit. The PV panel tilt angle is commonly configured for wintertime when day length is shortened, and the sun is low in the sky. Aiming to capture maximum solar energy when solar energy is scarce, the wintertime tilt angle of the PV panel in the northern latitudes is required to be high. However, the PV panel may be hosted on a gimbaled mount that allows for active (e.g., via a stepper motor) repositioning of the PV panel to maximize solar energy collection throughout the day.

The PV cells' surface area is sized to correspond to the anticipated power demand and the demand duration. To avoid masking the light emitted by the luminaire powered by PV panel/s, in at least one embodiment of the present disclosure, the PV panel/s is disposed above the light source of the luminaire.

High tilt mounting angle of the PV panel has intrinsic benefits-it prevents snow/ice accumulation, and habitation by birds. However, coupled to a pole, the high tilt mounting angle has two major disadvantages. First, when tilting the PV panels toward the sun, wind loads on the pole increase, necessitating stronger poles and support structure. Stronger poles require stronger foundations, adding costs to the pole assembly. Second, since the placement of the PV panels is contingent on the sun's orbit, the placement of the PV panels in relation to the light source power appears architecturally disjointed. Further, aside from the pole with the coupled luminaire and the PV panel/s, it is common practice to haphazardly couple a myriad of parasitic electrical devices, further contributing to an urban eyesore.

The pole mounted PV panel/s is positioned to capture maximum energy from the sun. As the surface temperature of the sun facing PV panel exceeds 95° C., the power generation capacity of the panel is reduced. For this reason, the panel's tilt angle and orientation are configured for the time of the year when the day hours are short. Nonetheless, maintaining the surface temperature of the PV panel/s below the threshold temperature is always desired.

The PV power generated by the sun during daylight hours is configured to be consumed by the light source and/or other power consuming devices at night. In configuring a lighting layout, the lighting designer sizes the PV panel/s capable of generating sufficient power to maintain the light source and/or the other coupled devices to the pole through the required duration of the night. In at least one embodiment, the sensing device coupled to the luminaire and/or the pole turn the light on when the sensing device senses an activity. Otherwise, the light is turned on/off by a control signal (triggered by time, and/or time of day) and/or a photocell (triggered by light level).

When an external power grid is in the vicinity, an alternate power management method can be used. The power generated by the pole coupled PV panel/s can be distributed through the grid to a remote device, and at night a portion or all of the power generated can be drawn back from the grid. While requiring additional equipment such as metering and communication devices, this power management method can over time generate a positive return on investment, as the cost of energy is higher during the day. Also, this method may require a smaller power storage device, thus reducing the assembly's installed cost.

The power generated by the PV panels can be stored by a power storage device that is also coupled to the pole. The power generated by photovoltaic cells is converted between DC and AC power. The power conversion device is commonly housed in proximity to the power storage device. The power storage device with the power conversion device housing is typically coupled to the pole in proximity to the PV panel/s. Placement of said housing above the mid-point of the pole height, while common, is undesirable as the housing with its content is rather heavy, inducing additional stresses on the pole.

Present-day pole mounted roadway and area lighting luminaire/s powered by PV panels today is driven by power efficiency and cost. Often, the elements comprising the pole assembly can be designed, supplied, and/or installed by different parties. As a result, often there is no placement hierarchy for the short- and long-lived electrical devices on the pole, the arm, and the luminaire. The PV self-powered pole assembly with light source long-lived devices can include at least one of: a solar panel, a light source, and a driver. The short-lived devices can include at least one of: a power storage device, and a processing/controlling device (programable circuitry, and/or hardwired circuitry, such as programmable array logic).

As recognized by the present inventor, key shortcomings of the present pole mounted roadway and area lighting luminaires powered by PV panel/s art include:
Loading the pole's higher section with heavy and voluminous structure/s translates to costly pole and foundation and expensive up-keep.
Failing to place short-lived electronic devices at the lower section of the pole translates to costly up-keep.
Absence of means to reduce the surface temperature of the PV panel during the hot summer months adversely affecting the panel's power generating capacity.
Placement of the PV panel and other system components at the most power efficient and inexpensive location on the pole, arm, and luminaire results in creating an urban eyesore.

The present innovation seamlessly integrates the PV technology with light source technology, creating novel architectural and engineered solutions for roadway and area illumination.

### SUMMARY

According to an aspect of the present disclosure, a new self-powered roadway luminaire using PV is described.

To overcome the limitations of conventional devices and systems as discussed above, the present innovation redistributes the system elements of the self-powered by PV technology roadway and area lighting luminaire. The five governing design considerations for the system elements re-distribution include:
(1) A system that comprises a pole, power inversion unit, a storage device that is coupled to the pole, and a luminaire housing structure that integrates a light source with a PV panel, wherein the placement of the elements is based on the element's form factor, weight, device life expectancy, ease of serviceability and first and life cycle costs.
(2) Horizontal or substantially horizontal PV panel placement.
(3) Luminaire form and capability to scale up to support different PV panel sizes and light source power input.
(4) Day and nighttime utilization of heat generated by the PV panel, and electronic device/s to reduce and/or control the devices coupled to the luminaire temperature.
(5) Luminaire device integration ability to support sensing, communication, monitoring, and processing devices with local and remote connectivity.

The redistribution of the PV system's elements separates the long-lived devices from the short-lived devices. The PV system's short-lived devices are typically heavy, and their enclosure is voluminous. Therefore, to reduce initial material and labor cost and subsequently maintenance costs, the present innovation places these devices below the mid-height of the pole. Where possible, it places this device in proximity to grade level.

Departing from the convention of tilting the PV panel toward optimal power generating sun angle, the present innovation proposes that ample power can be generated by positioning the PV panel/s substantially horizontally, compensating for the efficiency loss by increasing the PV surface area. The cost of the PV panels is reduced year by year, while the PV panel's efficiency increases year by year.

Integrating PV panels with roadway and area lighting luminaires demands a luminaire form factor that can accommodate different size PV panels without having to change the luminaire size. The present innovation solves this problem by introducing the Delta luminaire housing form. The Delta luminaire housing form couples to a pole at one end and at the other end can expand outwardly. The luminaire expansion can be done without encroaching on a neighboring luminaire/s. Further, in at least one embodiment a Delta luminaire pole arrangement induces a stream of air to flow through openings between the luminaire and the pole cooling the luminaire's warmed elements. The Delta luminaire form is planar, light weight with the PV panels coupled to a housing structure from above, and the luminaire's light source and other electronic devices coupled to the housing structure from below.

During daylight hours the Delta luminaire harnesses the heat generated by the PV panel to cool the PV panel/s and the at least the luminaire electrical devices. At night the delta luminaire extracts the heat generated by the at least the luminaire's electrical devices wherein the PV panel can help absorb and dissipate the heat. During winter months, the Delta luminaire electrical devices can help melt ice and snow accumulation on the PV panel. The thermal management attribute of the Delta luminaire results from the system's mechanical and electrical elements arrangement and thermal interdependency between them. For this reason, the PV panel and the luminaire are in proximity to one another, and both are coupled to an integrated housing structure.

The integrated housing structure of the Delta luminaire comprises a central elongated enclosure that extends diagonally across the bottom side of a square or rectangular frame. Structural support ribs extend outwardly and perpendicular from the elongated enclosure couple the elongated enclosure to the frame. In at least one embodiment, the elongated enclosure can extend beyond the frame and can become the Delta luminaire arm.

The Delta luminaire housing structure is configured to receive the PV panel from above and to couple to a plurality of electronic devices primarily from below. Among the devices coupled from below, several devices can be disposed inside compartments in the central elongated enclosure, while others can be coupled to the central elongated enclosure and/or the underside of the PV panel and the ribbed support structure.

The Delta luminaire has optional built-in provisions to address climatic conditions that can adversely impact the power generation capacity of the coupled photovoltaic panel. The provisions are geared to address ice/snow and dust accumulation. These provisions can rely on thermally passive and/or non-passive cooling/heating devices to remove ice/snow accumulation, and on fixed or mobile devices to remove dust accumulation from the Delta PV panel.

The devices coupled to the Delta luminaire can include at least one of, power supply, power conversion, a communication device, a sensing device, a processing device with resident memory and code. The code can embody at least one AI algorithm giving the Delta luminaire processor the ability to monitor and make actionable decisions based on sensory input, embedded operational parameters, and remote input. In addition, and for example, the Delta luminaire housing with or without the PV panel and the light source, can host a UAV and utilize the top surface as a launch pad and/or power/signal docking station.

Lastly yet importantly, the pole mounted Delta luminaire's modularity and scalability can become a base platform for an urban power generation grid. The existing street lighting poles with existing luminaires or newly installed can employ at least one Delta luminaire and a plurality of Delta luminaire housing structures, each coupled to a PV panel. The cumulative power generated by the PV panels' assembly can exceed the power needed to power the luminaire. The excess power can be transmitted directly to the local grid, reducing the dependency on remotely generated power.

In at least one power management configuration, the power generated during the day can be directly transmitted to the local grid, while at night, when power rate is lower, at least a portion of the power can be transmitted back to energize the coupled luminaire. It is noted that based on the following assumptions: a city with 10,000 roadway poles, each pole with 36 sq.-ft PV panels, 15 W/Hr. power generation capacity, 8 hrs./day of power generation cycle and 360 days/year, 15.55 million kWh can be generated. Further, the increased shaded surface area of approximately 8.5 acres will help reduce the urban heat island effect.

In the following description of FIGS. 1-13 an exterior lighting system is powered by at least one integrated photovoltaic panel. The text associated with FIGS. 1-13 describe a pole top light weight assembly comprising PV panel/s and luminaire/s, primarily configured as a pole mounted application. The pole top coupled devices are configured to be long-lived (e.g., mean time between failure of e.g., 500,000 hours, 1,000,000 hours or more, thus requiring infrequent service. The heavy and relatively short-lived system's components (mean time between failures being lower than the mean time between failures of the long-lived top-coupled devices) are shown located below two thirds of the pole's height. The placement location of the short-lived components can be at the pole base or elevated above and below the pole top arm/s. The decision on where the short-lived heavy weight components, and the long-lived light weight components coupled to the PV pole location is typically dependent on the pole's location and specified utility derived from the PV pole application.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIGS. 1A, 1B, and 1C show main elements of the pole mounted Delta luminaire.

FIGS. 1D and 1E show an exemplary partial elevation of a base of the pole.

FIGS. 2A, 2B, 2C, and 2D show respective 1, 2, 3, and 4 pole mounted truncated Delta luminaire arrangements.

FIGS. 2E, 2F, 2G, and 2H show respective 1, 2, 3, and 4 pole mounted extended arm Delta luminaire arrangements.

FIGS. 3A, 3B, and 3C show three truncated Delta luminaires with 15, 24, and 35 photovoltaic panels respectively.

FIGS. 3D, 3E, and 3F show three extended arm Delta luminaires with 4×4, 5×5, and 6×6 photovoltaic panels respectively.

FIGS. 4A and 4B show top views of the integrated Delta luminaire housing structure, which FIG. 4A showing the truncated Delta luminaire and FIG. 4B showing the extended arm Delta luminaire.

FIGS. 5A and 5B show bottom views of the integrated Delta luminaire housing structure, with FIG. 5A showing the truncated Delta luminaire and FIG. 5B showing the extended arm Delta luminaire.

FIGS. 6A and 6B show side and frontal views of the truncated Delta luminaire coupled to a pole respectively.

FIGS. 6C and 6D show side and frontal views of the extended arm Delta luminaire coupled to a pole respectively.

FIG. 7A shows a frontal section of the delta luminaire.

FIGS. 7B and 7C show respective longitudinal sections through the driver housing of the truncated and extended arm Delta luminaire.

FIGS. 8A and 8B show bottom view perspectives of the Delta luminaire coupled to a pole. FIG. 8A shows externally coupled electrical devices and FIG. 8B shows the interior enclosure/s of the driver's housing of the delta luminaire.

FIGS. 9A and 9B show sections of a pole with an assembly of truncated Delta luminaire coupled and transverse Delta luminaire passive cooling respectively.

FIGS. 10A, 10B, and 10C show structures to prevent dust accumulation on the Delta PV panel. The structures of FIGS. 10A and 10B are coupled to structure, and FIG. 10C is mobile.

FIGS. 11A, 11B, 11C, and 11D show an exemplary ground mounted PV devices enclosure. FIGS. 11A and 11B show front and top views respectively, and FIGS. 11C and 11D show a transverse section and a longitudinal section respectively.

FIG. 12 shows an exemplary day and nighttime power distribution diagram of the pole mounted Delta luminaire with a coupled PV panel.

FIG. 13 is a block diagram of a computer-based system (e.g., controller and/or processor which are examples of circuitry-including fully or partially programmable circuitry and hardwired circuitry) that provide processing functionality to perform the control and analytics aspects of the present disclosure.

FIGS. 14A and 14B show front and back views and FIGS. 14C and 14D show the top and bottom views of the inverter pod housing respectively.

FIGS. 15A, 15B, and 15C show side and top views of PV pole partial sections retaining an inverter pod.

FIGS. 16A and 16B show partial vertical cross-sections of an inverter pod housing supported by an electromechanical arm and a bracket flange respectively to a PV pole.

FIG. 17 shows a bottom view of an inverter pod supported by an electromechanical arm that is coupled to a PV pole.

FIGS. 18A and 18B show opposite sides of a bracket that is configured to vertically support an inverter pod orientation.

FIGS. 19A and 19B show a partial top and a partial side view of a flange bracket coupled to a PV pole respectively.

FIGS. 20A and 20B show exemplary PV pole assembly configurations suited for highway and parking lot applications respectively.

FIG. 21 shows a PV pole assembly configured to include a signaling device.

### DETAILED DESCRIPTION

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

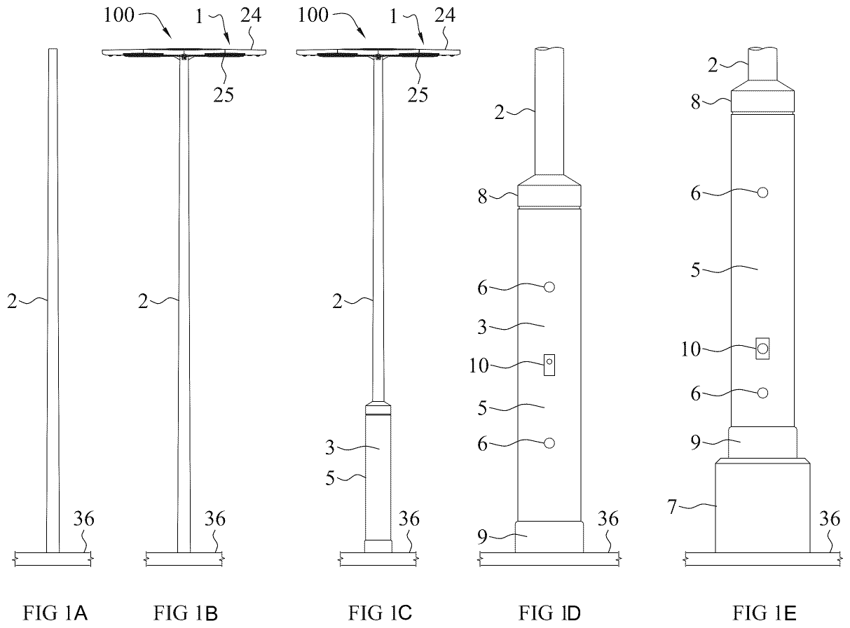

FIGS. 1A, 1B, and 1C show main key elements of the pole mounted Delta luminaire. FIG. 1D shows an exemplary partial elevation of the pole's base.

FIG. 1A shows a pole 2. The pole 2 can be made of metallic material, non-metallic material or a combination of the two. The pole 2 can be embedded in the ground 36 or can be resting on a pole plate and coupled to a foundation 7 (FIG. 1E) with anchor bolts. The pole 2 can be straight-shafted or tapered. The pole profile can be square, round, or segmented. The pole 2 can comprise at least one section and can have recesses and/or protrusions extending inward or outward from its surface. The pole 2 can also have at least one bore 41 to mechanically couple an external device and/or to convey power/data conductor/s 40 to and/or from the pole's 2 interior.

FIG. 1B shows a plurality of Delta luminaires 100, 1 coupled to the pole 2 top. Two of the luminaires 1 shown extend sideways and the center luminaire 1 extends toward the viewer. A PV panel 24 is coupled to the luminaire 1 on top, and a light source 25 is coupled to the luminaire's bottom. The assembly of the Delta luminaires 100, 1 are shown to slope down as they extend outwardly from the pole 2. The slope removes fluid from ponding on the coupled PV panels 24. In winter, heating devices 29, 30 built into the Delta luminaire 1 housing structure 50 can prevent snow/ice accumulation over the PV panel 24, shedding away the melted ice/snow water.

FIG. 1C shows a pole 2 mounted luminaire assembly 100 comprising a pole 2 coupled to a plurality of Delta luminaires 1 with a PV device enclosure 5 located around the pole 2 at the base of the pole's 2. Also shown a PV panel 24 coupled to the luminaires 1 on top, and a light source 25 coupled to the luminaire's bottom. The PV device enclosure 5 can, at least in part, house at least one of a short-lived device, a heavy device, and a bulky device of the PV power generation system. In addition, other devices can be coupled to the PV power enclosure 5, serving related and/or unrelated services associated with the self PV power generated roadway and area lighting pole 2 mounted system.

FIG. 1D shows an enlargement of the pole's base surrounded by the PV device enclosure 5. There are several reasons to place the short-lived, heavy, and bulky devices at the lower half of the pole 2. These reasons include:
The higher these devices are placed on the pole, the stronger the pole and foundation required.
The shorter the life of the device, the more frequent maintenance the device requires.
Having the device mounted at easily accessible height saves machine and laborer costs.

Other than the PV power generating devices retained inside the enclosure housing, other non-related devices can be retained inside or coupled to the enclosure housing. For example, an enclosure for a pole positioned by a crosswalk can also have a sensing device switching the traffic light when sensing occupancy.

The devices coupled to the PV device enclosure 5 and/or the pole 2 partially or fully surrounded by the PV device enclosure 5 with the power storage and control unit 3 concealed inside. The elements of the power storage and control unit 3 can include at least one of, an inverter 4, a battery 46, a power management controller 47, a fuse 52, a power disconnect 49, a sensing device 10, and a communication device 11. The battery/s 46 can be positioned at the opposite side of pole 2 that faces the sun much of the year. The interior of the PV device enclosure 5 can include at least one of, a thermal blanket 29, and a heat reflecting and non-conductive pad 51. Such accessories can be coupled to the PV device enclosure 5 based on the climatic conditions at the installation's location.

The PV device enclosure 5 can include a lock 6. The lock 6 can be a digital code lock that bars entry to the PV device enclosure's 5 interior. A sensing device 10 can couple to the exterior surface of the PV device enclosure 5. When a pole mounted luminaire assembly 100 is placed in proximity to a crosswalk, the coupled sensing device 10 can help control the pedestrian and vehicular traffic at the crosswalk.

PV device enclosure 5 can be elevated from the ground 36 to avoid contact with run-off water. A power storage and control unit base shown elevated the PV device enclosure 5 from the ground 36 and a power and control cap 8 protects the interior of the enclosure 5 from moisture penetration from above. The PV device enclosure 5 can be formed to complement the architecture of the pole 2 assembly. The PV device enclosure 5 material can be made of metallic material, non-metallic material, non-corrosive material, non-conductive material, and/or non-flammable material.

FIG. 1e shows the PV device enclosure 5 of FIG. 1d elevated and resting on a concrete base 7.

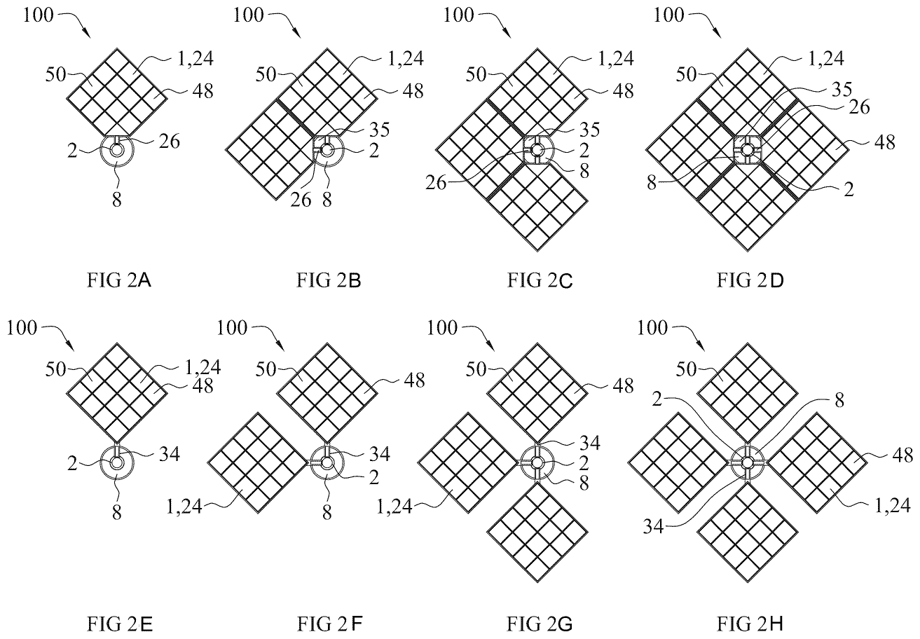

FIGS. 2A, 2B, 2C, and 2D show 1, 2, 3 and 4 pole mounted truncated arm 26 Delta luminaire assembly 100. The truncated arm 26 Delta luminaire 1 is primarily suited for area lighting and/or where there is a need to generate more power requiring more PV panel 24 surface area. The surface area of the PV panel 24 is comprised of a plurality of sub-panels 48 modules. The Delta formed housing structure 50 can support other power consuming devices. For example, the top surface of the Delta formed housing structure 55 can become a launching pad and/or an electrified docking station for an unmanned arial vehicle (UAV, not shown).

When a plurality of truncated arm 26 Delta luminaires 1 are coupled to a pole 2 from all sides, a through air opening 35 forms between the pole 2, the Delta luminaires 1, and the luminaire's arm 26. As the temperature, coupled from above PV panel's, rises during daytime operation, cool air from below the Delta luminaires 1 is induced to flow through the through-air openings 35 to above. The flow of air employing the chimney and Venturi effects cools the underside of the Delta luminaires 1 with its coupled electrical devices 55.

FIGS. 2E, 2F, 2G, and 2H respectively show 1, 2, 3, and 4 pole mounted extended arm 34 Delta luminaire 1 arrangements. The Delta luminaire 1 with extended arm 34 is primarily suited for roadway applications where a single luminaire illuminates a segment of the road. The Delta luminaire 1 extended arm 34 can be an extension of the elongated enclosure 19 (not shown) that forms the spine of the luminaire 1. The extended arm 34 Delta luminaire 1 extends outwardly to form an air gap between two adjacent luminaires. The extended arm 34 exposes a single or a Delta luminaire 1 assembly to cooling flow of air from below from all sides.

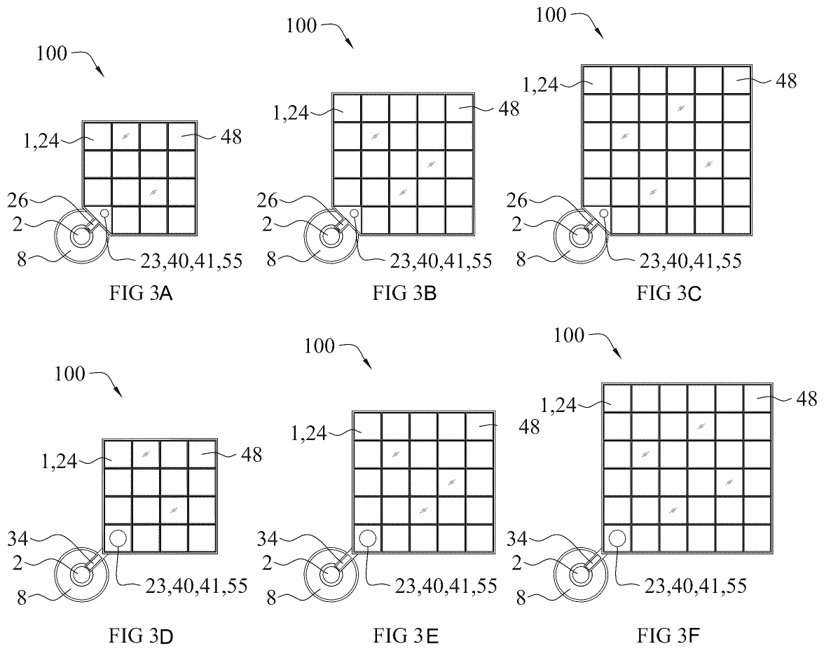

FIGS. 3A, 3B, and 3C show three pole assemblies 100 with truncated arm 26 Delta luminaires 1. The Delta luminaires 1 shows an arrangement of 15, 24, and 35 photovoltaic sub-panel 48 modules. The triangular area by the truncated arm 26 of the Delta luminaire 1 can be coupled to at least one of, a triangular sub-panel 48, an electrical receptacle 23, and an up facing electrical device 55. The area by the truncated arm 26 end can also provide an access bore 41 for at least one electrical conductor's 40 connectivity to the interior of the elongated enclosure 19. The frame 20 walls by the triangular area can be reinforced to enable elongated fasteners 53 to couple the Delta luminaire's 1 truncated arm 26 to a pole 2. The truncated arm 26 Delta luminaire 1 retains a PV panel 24. The PV panel's 24 size is scalable and can expand beyond the number of sub-panels 48 shown.

FIGS. 3D, 3E, and 3F show three extended arm 34 Delta luminaires 1 with 4×4, 5×5, and 6×6 photovoltaic sub-panels 48. The extended arm 34 Delta luminaire 1 has a square form with a grid comprising an equal number of photovoltaic sub-panels 48 within the frame 20 walls. The extended arm 34 length can be designed for any length and can be fabricated unitarily with the elongated enclosure 19 that forms the spine of the Delta luminaire 1. As with the truncated arm 26 of the Delta luminaire 1, at least a portion of the top surface of the Delta luminaire 1 can be coupled to at least one of, an up facing electrical device 55, and an electrical receptacle 23. The extended arm's 34 end can also have an access bore 41 for at least one electrical conductor's 40 connectivity to the interior of the elongated enclosure 19.

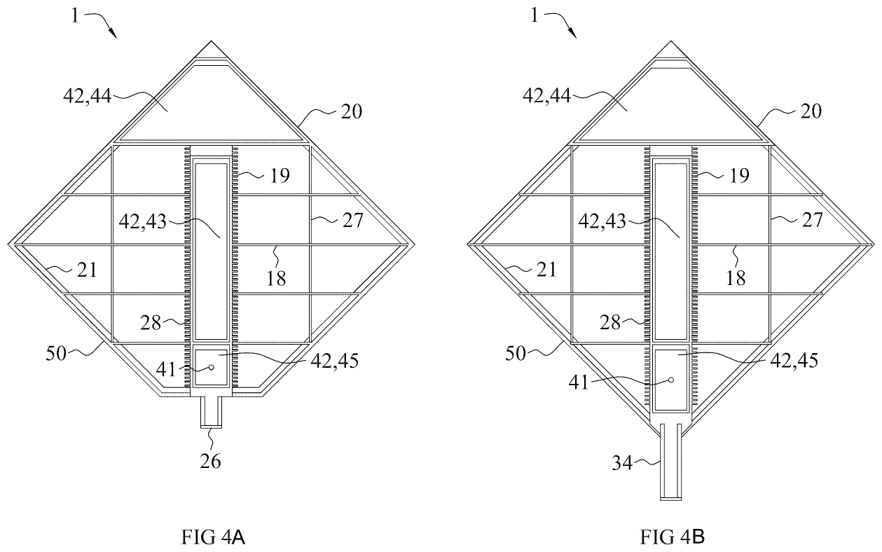

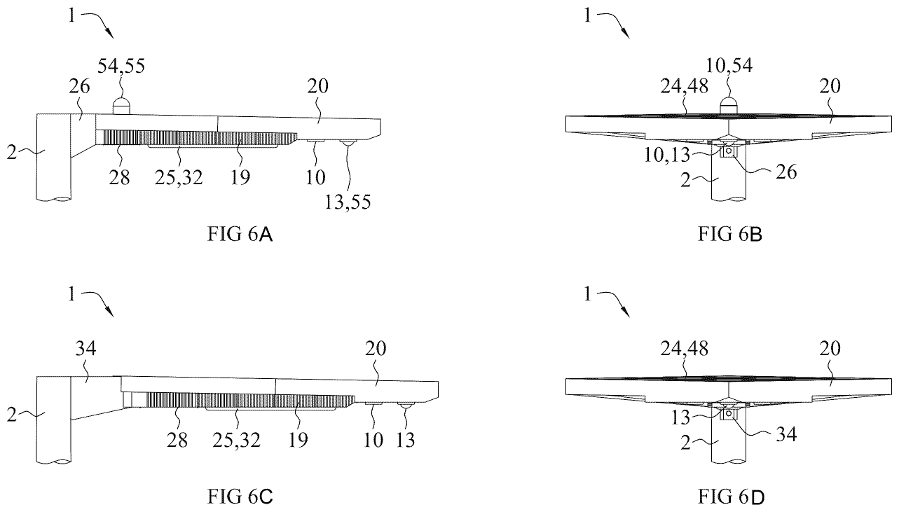

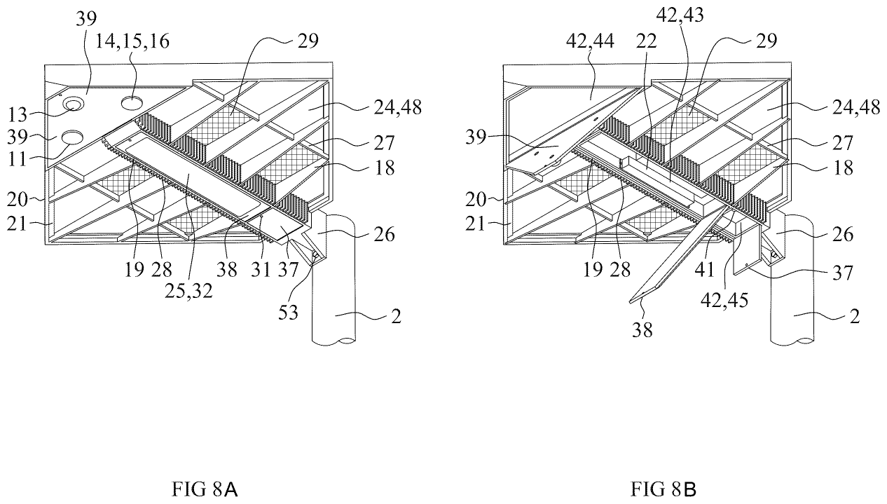

FIGS. 4A and 4B show ground facing views of the integrated Delta luminaire 1 housing structure 50 with FIG. 4A showing a truncated arm 26 and FIG. 4B showing an extended arm 34. For clarity, the figures show the elongated enclosure 19 of the housing structure 50 without coupled covers 37, 38, and 39 (not shown). The elongated enclosure 19 supports the luminaire's 1 structure with its coupled devices. Also, for clarity, the present figures do not show electrical devices and PV related elements. For a more complete depiction, refer to FIGS. 6 and 8.

The elements of the Delta luminaire 1 housing structure 50 as seen from below include a central elongated enclosure 19 that extends diagonally across the bottom side of a squared or substantially squared frame 20. The elongated enclosure 19 is also referred to herein as the spine. The Delta luminaire's 1 elongated structure 19 couples to an arm. The arm can be a truncated arm 26 or an expanded arm 34. Both arms can be unitarily fabricated with the Delta luminaire 1 housing structure 50. The truncated arm's 26 connectivity to the luminaire's 1 housing structure 50 differs from the extended arm 34 Delta luminaire 1. Elsewhere, the luminaire's housing structure 50 can be substantially or entirely the same.

The elongated enclosure 19 has at least one compartment 42. The present figures show three compartments 42—a power supply compartment 43 in the center, a splice box compartment 45 coupled to the arm, and a device enclosure 44 at the opposite end of the elongated enclosure 19. The elongated enclosure 19 compartments 42 can have at least one of, a through bore 41 to enable conveyance of power/data conductor/s and a venting aperture for warm air to exit the enclosure 42.

The power supply compartment 42, 43 can retain at least one power supply 22 (not shown) and can be enclosed by a power supply cover 38 (not shown). The power supply cover 38 can be secured to the elongated enclosure 19 with a mechanical fastener 31 (not shown). At the other end, the power supply cover 38 can be coupled to the elongated enclosure 19 with a hinge 57 (not shown). The power supply cover 38 can be detachable. The exterior facing side of the power supply cover retains the light source 25 (not shown) with a protective lens 32 (not shown). The power supply cover 38 can also become a heat sink. The size of the power supply cover 38 can expand as needed to accommodate the light output demand on the luminaire 1.

The elongated enclosure 19 couples at the arm's 26, 34 side to a compartment 42 that is the luminaire's splice box 45. As with the power supply compartment 43, the splice box 45 can be enclosed by a splice box cover 37 (not shown). At least one bore in a wall of the splice box compartment 45 with a through power/data conductor can convey power/signal to and from the splice box compartment 45. The present figure shows a bore 41 at the roof of the splice box 45.

At the opposite side of arms 26, 34, the elongated enclosure 19 can expand, forming a triangular compartment 42. The compartment 42 can be enclosed by device tray 39 (not shown). The expanded area of the compartment 42 with the device tray 39 is suitable for coupling a plurality of electrical devices 55. The devices that can couple to the device tray 39 (not shown) can include at least one of, a sensing device 10, a communication device 11, and a processing device 12. The devices coupled can be operationally unrelated, or related in part, to the operation of the coupled Delta luminaire 1.

Structural support ribs 18 incrementally extend outwardly and perpendicularly from the elongated enclosure 19 and couple the elongated enclosure 19 to the frame 20. The ribs 18 can extend above the elongated enclosure 19 creating a through air gap 33 (not shown) between the PV panel's 24 (not shown) bottom, side, and top surfaces of the elongated enclosure 19. Stiffeners 27 perpendicularly coupled to the ribs 18 can provide additional rigidity to the Delta luminaire 1 structure. At least one of, a lip 21 coupled to the inner walls of the frame 20, a rib 18, and a stiffener 27 can support the weight of the PV panel 24 that is coupled to the housing structure 50 from the above.

Fins 28 that extend outwardly from the elongated enclosure 19 spine of the Delta luminaire 1 dissipate heat generated by at least one electrical device 55 that is coupled to the elongated enclosure 19. The fins 28 can be unitarily coupled to the elongated enclosure 19 and can extend a portion or the full length of the elongated enclosure 19.

Other aspects of the present figures not shown include:
Both the truncated arm 26 and the extended arm 34 Delta luminaires 1 can have at least one electrical or an electrical and data receptacle 23 on the top surface of the elongated enclosure 19. Such a receptacle 23 can couple to a reciprocating receptacle 23 coupled to the back side of the PV panel 24. Once the PV panel 24 is secured in place, electricity can flow from the PV 24 panel into the elongated enclosure 19. Power and/or data conductor from the top of the Delta luminaire 1 housing structure 50 can enter the splice box 45 of the elongated enclosure 19 through bore 41.

Thermal conductors 30 extending from inside the elongated enclosure 19 can be placed on top of at least one rib 18 that is in contact with the bottom side of the PV panel 24. During the night when the light source 25 is on, heat generated by at least one of the light source 25 and a power supply 22 can be conducted through the conductor/s 30 to the bottom side of the PV panel 24. Especially during the summer nights, the removed heat prolongs the life of the Delta luminaire's 1 coupled electrical devices 55. In winter, when snow/ice can accumulate over the PV panel 24, the conductor/s 30 can help melt the snow/ice.

In cold environments “plug 'n play” receptacles 23 disposed at the top surface of the elongated enclosure 19 can couple to reciprocating receptacles 23 disposed at the bottom of the PV panel 24. The receptacles 23 coupled to the bottom of the PV panel 24 can be electrically coupled to electrical thermal blankets 29 that are secured to the bottom of the PV panel 24. By a signal from a remote location and/or by input from a coupled sensing device 10 (not shown), the electrical thermal blanket 29 can generate sufficient heat to melt any snow/ice accumulation on the top face of the PV panel 24.

The integrated Delta luminaire 1 housing structure 50 can be fabricated using metallic materials, non-metallic materials, or a combination of both. The housing structure can be fabricated by at least one process of: molding, casting, and 3D printing. The housing structure 50 can be made to be anti-corrosive, anti-flammable, and resistant to UV radiation. The housing structure 50 can be painted, anodized, or galvanized.

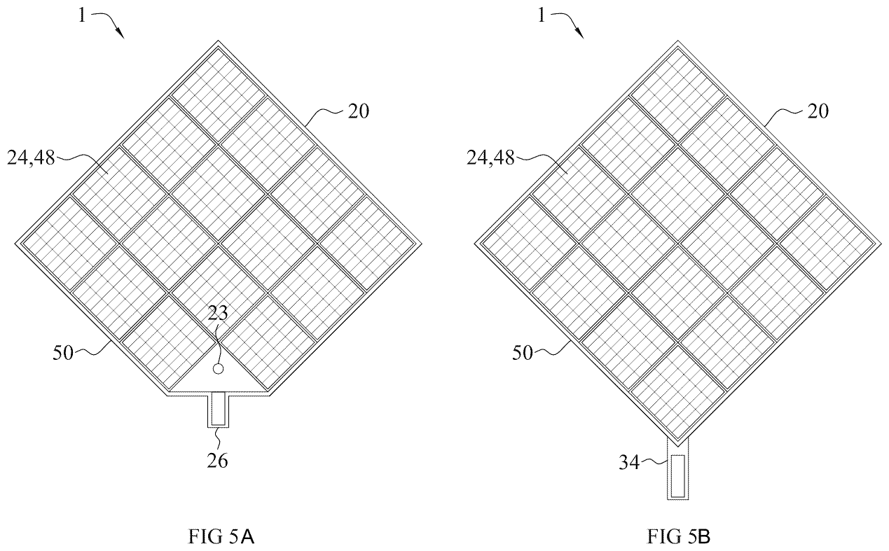

FIGS. 5A and 5B show the top views of the integrated Delta luminaire 1 housing structure 50. FIG. 5A shows the Delta luminaire 1 with a truncated arm 26 and FIG. 5B shows the Delta luminaire 1 with an elongated arm 34.

PV panels 24 divided by a grid of PV sub-panels 48 are shown secured from above to the housing structure 50 of the Delta luminaire 1. The PV panel 24, 48 is shown resting within the frame 20 walls of the housing structure 50. The Delta luminaire form slightly varies at the arm's end. The Delta luminaire 1 coupled to the truncated arm 26 form is truncated. The present figure shows an uncovered area by the PV panel 24, 48 with a receptacle 23 that can convey power and/or data to the interior of the elongated structure 19.

It is noted that the form of the Delta luminaire 1 coupled to a pole 2 can be scaled up. The need to scale up a Delta luminaire 1 is driven by a greater need for power generation. The form of the Delta luminaire 1 enables scaling up the luminaire with a corresponding PV panel 24, without a conflict with a neighboring coupled luminaire 1. The PV panel can be shipped to the construction site installed or be installed onsite.

The integrated Delta luminaire 1 housing structure 50 can be fabricated using metallic materials, non-metallic materials, or a combination of both. The housing structure can be fabricated by at least one process of: molding, casting, and 3D printing. The housing structure 50 can be made to be anti-corrosive, anti-flammable, and resistant to UV radiation. The housing structure 50 can be painted, anodized, or galvanized.

FIGS. 6A and 6B show the side and frontal views of the truncated Delta luminaire coupled to a pole. FIGS. 6C and 6D show the side and frontal views of the extended arm Delta luminaire coupled to a pole.

FIGS. 6A and 6B show the side and frontal views of the truncated arm 26 Delta luminaire 1 coupled to a pole 2. The Delta luminaire 1 is slimline, with a minimal Effective Projected Area (EPA). A lower EPA luminaire is subjected to lower wind loads. A lower wind load on the at least one luminaire shown coupled to a pole 2 reduces the cumulative lateral loads on the pole 2 which translate to a lighter pole 2 wall gauge and/or smaller pole 2 diameter. Lighter pole 2 gauge and/or smaller pole 2 diameter cost less.

FIG. 6A, the side view of the truncated arm 26 Delta luminaire 1, shows the protective frame 20 extending around the Delta luminaire 1. In at least one embodiment the frame 20 can merge or be formed to become the luminaire's 1 mounting arm 26 to the pole 2. The present embodiment shows a light source 25 horizontally coupled to the bottom of the elongated enclosure 19 of the luminaire 1. A lens 32 disposed over the light source 25, can emit light in a plurality of light distribution patterns. Heat dissipating fins 28 are shown coupled to the wall of the elongated enclosure 19.

The luminaire 1 at one end is shown coupled to a pole 2, and at the other end a plurality of electrical devices 55 are shown coupled to the bottom of the luminaire 1. The electrical devices 55 shown are coupled to a reduced depth portion of the elongated enclosure 19. Also, at the top of the luminaire 1 in proximity to the arm 26, a photocell 54 is shown coupled. In a different embodiment, at least one different electrical device 55 can be coupled to the top of the truncated arm 26 Delta luminaire 1 with a partial, full, or no PV panel 24 coverage on top of the luminaire 1.

The present embodiment shows the light source 25 coupled to the bottom of the elongated enclosure 19 mounted horizontally; however, the top of the luminaire 1 is shown sloping downward and away from the pole 2. The slope of the structure is intended to swiftly remove water from the face of the PV panel 24. The angle of the slope is relatively shallow, but sufficient to remove water with minimal impact on the PV panel's 24 power production efficiency.

FIG. 6B, the frontal view of the truncated arm 26 Delta luminaire 1, shows the luminaire's frame 20 protecting the electrical devices 55 coupled to the luminaire 1. PV panel 24 comprising a plurality of sub-panels 48 is shown disposed from above within the frame's 20 walls. The angled frame 20 diverts the wind to the side and away from the luminaire 1, further reducing the stress on the pole 2. In addition, the sloping downward luminaire 1 form, help direct lateral wind load down on to the pole 2. The elongated enclosure 19 coupled to the pole 2 at the opposite end cantilevers across the length of the luminaire 1, carrying the weight of the luminaire 1 with its coupled electrical devices 55 and/or mechanical devices.

The cantilevered elongated enclosure's depth is shown to vary, becoming shallower at the end opposite to the pole 2. Reducing the depth of the elongated enclosure 19 contributes to lesser EPA on the luminaire 1 and enables expanding the elongated enclosure's 19 device retainage area to support coupling a plurality of electrical devices 55. The present embodiment shows three electrical devices 55 coupled-two sensing devices 10, 13 and one communication device 11.

FIGS. 6C and 6D show the side and frontal views of the extended arm 34 Delta luminaire 1 coupled to a pole 2.

FIG. 6C, the side view of the extended arm 34 Delta luminaire 1, shows the protective frame 20 extending around the luminaire 1. The present embodiment shows a light source 25 horizontally coupled to the bottom of the elongated enclosure 19 of the luminaire 1. Heat dissipating fins 28 are shown coupled to the wall of the elongated enclosure 19.

The luminaire 1 at one end is shown coupled to a pole 2 by an extended arm 34, and at the other end a plurality of electrical devices 55 are shown coupled to the bottom of the luminaire 1. The electrical devices 55 shown are coupled to a reduced depth portion of the elongated enclosure 19. In a different embodiment, at least one electrical device 55 can be coupled to the extended arm 34 or to another top surface of the extended arm 34 Delta luminaire 1.

The present embodiment shows the light source 25 coupled to the bottom of the elongated enclosure 19 mounted horizontally; however, the top of the luminaire 1 is shown sloping downward and away from the pole 2. The slope design's intent is to swiftly remove water from the face of the PV panel 24k. The angle of the slope is relatively shallow, sufficient to remove water with minimal impact on the PV panel's 24 power production efficiency.

FIG. 6D, the frontal view of the extended arm 34 of the Delta luminaire 1 is as described in FIG. 6B.

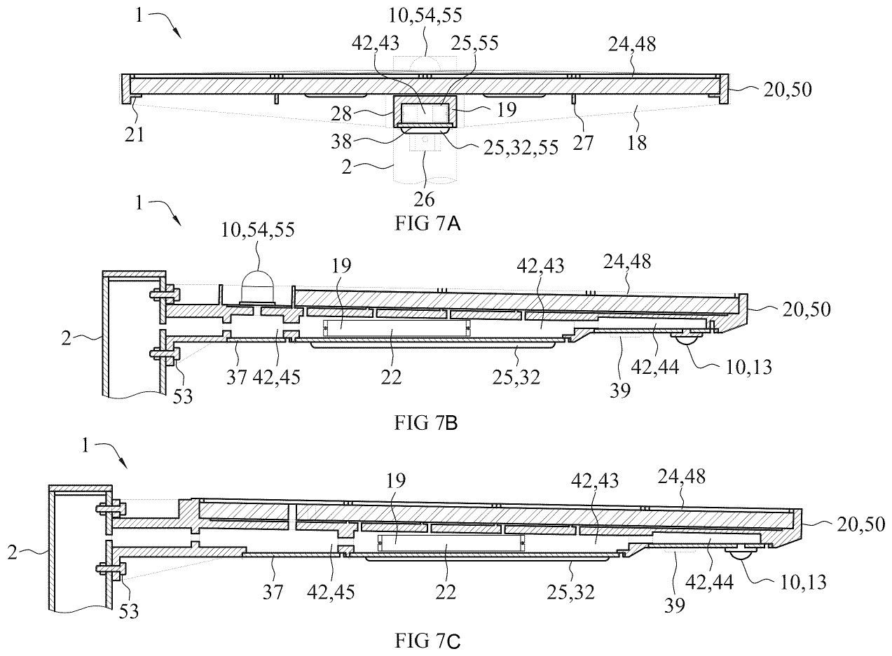

FIG. 7A shows a transverse section of the Delta luminaire 1. FIGS. 7B and 7C show longitudinal sections through the elongated enclosure 19 and the truncated arm 26 and the extended arm 34 of the Delta luminaire 1, respectively.

FIG. 7A shows a transverse section in front of and along the longest support rib 18. As shown, the rib 18 couples to the elongated enclosure 19 from both sides and extends higher than the top surface of the elongated enclosure 19. At both sides of the elongated enclosure 19, coupled heat dissipating fins 28 shown extend outwardly. Inside the elongated enclosure 19, two power supplies 22 are shown coupled to the walls. At the bottom of the elongated enclosure 19 a light source 25 with a protective optical lens 32 is shown coupled to an opening in the elongated enclosure 19 cover. A power supply cover 38 can enclose the opening and become the heat sink of the light source 25. The power supply cover 38 can be detachable and expandable, retaining additional light source 25 modules.

Long-lived electrical devices 55 can be housed inside the power supply compartment 43. The electrical devices 55 housed can include at least one of, a power supply 22, a surge protector 56 (not shown), a processor 12 (not shown), a communication device 11 (not shown), and a sensing device 10. The cross-section of the elongated enclosure 19 can have more than a single compartment 42. In at least one embodiment, line voltage and low voltage conductors 40 (not shown) are segregated and are disposed in separate compartments 42.

Receptacles 23 (not shown) configured to couple to at least one electrical device 55 can couple to the interior and exterior surfaces of the elongated enclosure 19 compartment 42 walls. The receptacles 23 can convey at least one of power and data. The Delta luminaire 1 can employ a universal receptacle 23 to couple to an array of electrical devices 55. Further, the electrical devices 55 coupled can be in part or fully communicatively coupled to at least one onboard processor 12 with resident memory and code. The processor can also be disposed inside the PV device enclosure 5 (not shown).

In at least one embodiment, at least one thermal conductor 30 that originates at the elongated enclosure's 19 interior can convey heat across and on top of at least one rib 18 to warm the back side of the PV panel 24. In an alternate embodiment shown, electrical thermal blankets 29 can be coupled to the back side of the PV panel 24 and can generate heat when at least one of, temperature drops below freezing, and moisture and/or weight pressure is sensed across the top surface of the PV panel 24.

Stiffeners 27 shown crossing the support ribs 18 add rigidity to the Delta luminaire 1 housing structure 50 with the ribs 18 shown coupled to the exterior protective frame 20. A lip 21 shown coupled to the interior face of the protective frame 20 is configured alone, or with at least a portion of a top of a rib 18 to support the weight of a coupled PV panel 24.

The PV 24 panel can have a “plug 'n play” receptacle 23 on the back side of the PV panel 24. Upon placing the PV panel 24 on the lip 21 within the protective frame 20, the receptacle 23 can electrically engage a reciprocating receptacle 23 built into the elongated enclosure's 19 top surface, thus conveying power generated by the PV panel 24 to the interior of the elongated enclosure 19.

FIGS. 7B and 7C show longitudinal sections through the elongated enclosure 19, the truncated arm 26, and the extended arm 24 of the Delta luminaire 1 respectively.

The section of the elongated enclosure 19 of the Delta luminaire 1 shows three compartments 42. The voltage and/or the power (AC/DC) flowing in/out of these compartments 42 corresponds to the electrical devices 55 coupled to the compartments' 42 walls and corresponding covers. The compartment 42 next to the arms 26, 34 can be a splice box 45. The middle power supply compartment 43 can house at least one line voltage electrical device 55 such as a power supply 22. The compartment 42 at the opposite end of the elongated enclosure's 19 splice box 45 can house and/or its device tray 39, and/or can couple to at least one low voltage electrical device 55.

A receptacle 23 shown above the elongated enclosure's 19 splice box 45 and below the PV panel 24 enables power flowing from the PV panel 24 to enter the splice box 45. The splice box 45 can have isolated compartments for DC and AC power. A plurality of through conductors 40 passing through bores 41 in the splice box 45 wall can convey low voltage, line voltage and data signal. The conductors 40 connect the Delta luminaire's 1 coupled electrical devices 55 to at least one of an electrical device 55 coupled to the pole 2, an electrical device 55 coupled to the PV enclosure 5, and is communicatively coupled to remote device/s.

At the bottom of the elongated enclosure's 19 center compartment 42, a power supply cover 38 with a light source 25 and a protective optical lens 32 is shown over the compartment's 42 opening. The power supply cover 38 can be the light source's 25 heat sink. The power supply cover 38 can be detachable and expandable, retaining additional light source 25 modules.

The present figure shows three enclosed compartments 42. The compartments' splice box cover 37, the power supply cover 38, and the device tray 39 can open to the below, exposing the elongated enclosure 19 compartments' 42 interior with its coupled electronic devices 55. The at least one splice box cover 37, power supply cover 38, and the device tray 39 can be detachable. The low voltage electrical devices 55 coupled to the device tray 39 can include at least one sensing device 10 such as a camera 13. Input from a camera 13 that is coupled to a processor 12 can then in real time process inputs and generate actionable outputs. The actionable outputs can relate to the immediate coupled luminaire/s 1 and/or an electrical device 55 coupled to the pole 2, a plurality of neighboring poles 2 with their coupled electrical devices 55, and other remote client/s.

The placement location of the electrical devices 55 in and on the Delta luminaire 1 must be weighed in relation to other neighboring electrical devices 55. For example, placing a camera 13 next to a light source 25 can be problematic if apparent glare can't be mitigated. Further, if the camera 13 is placed in proximity to a pole 2, a portion of the camera's 13 field of vision can be blocked. Furthermore, if the luminaire 1 is subject to vibration, without corrective software, the image generated by the camera 13 can be blurry. The Delta luminaire's 1 camera 13 placement is shown away from the pole 2, recessed above the light source 25, and secured to the elongated enclosure's 19 device tray 39.

Both the truncated arm 26 and the extended arm 34 Delta luminaires 1 employ an arm 26, 34 for coupling to a vertical structure. The structure can be a pole 2 or a wall surface. The present figures show an elongated fastener 5 coupling the Delta luminaire 1 to the pole 2. Both the truncated arm 26 and the extended arm 34 can be fabricated as a unitary extension of the luminaire 1. In a different embodiment, at least one Delta luminaire 1 can have a detachable arm that can couple to the luminaire 1. The arm can extend in length, as required, and may house at least one electrical device 55.

FIGS. 8A and 8B show bottom view perspectives of the truncated arm 26 Delta luminaire 1 coupled to a pole 2. FIG. 8A shows externally coupled electrical devices 55 and FIG. 8B shows the interior compartment 42, 43 of the power supply 22 of the Delta luminaire. Excluding arms 26, 34, the housing structure 50 and the electrical devices 55 coupled to the Delta luminaire 1 can be the same.

FIG. 8A shows the diagonally disposed elongated enclosure 19 extending from the center of the luminaire 1 out to form an arm 26, 34 at one end, and at the opposite end to form a compartment 42. The three covers shown enclosing the three interior compartments 43, 44, 45 of the elongated enclosure 19 are a splice box cover 37, a power supply cover 38 that is also referred to herein as the heat sin, and a device tray 39. The covers 37, 38, 39 can open to the below and are secured to the elongated enclosure 19 by a mechanical fastener 31.

At least one electrical device 55 can couple to each one of the covers 37, 38, 39. In addition, in at least one embodiment, an electrical device 55 coupled to the cover 37, 38, 39 can be detachable. The present embodiment shows at least one hinge 57 coupling from one end of the cover 37, 38, 39 to the elongated enclosure 19. In different embodiments (not shown), other coupling means can be used. The covers 37, 38, 39, secured in position, can be designed to prevent moisture from entering the interior compartments 43, 44, 45 of the elongated enclosure 19.

In the present embodiment, the covers' 37, 38, 39 exterior surfaces can be tasked with different operational aspects of the Delta luminaire 1. The splice box 45 cover 37 can be coupled to a fuse 52 and/or a surge protector 56. The cover provides access to the compartment 42 to connect/terminate the power or power and data conductors 40. At the opposite end of the elongated enclosure 19, the enlarged exterior surface of the device tray 39 enables coupling a plurality of electrical devices 55. The electrical devices 55 can include at least one of, a sensing device 10, a communication device 11, a data and/or power storing device 3, and a processing device 12.

At the center of the elongated enclosure 19, a power supply heat sink cover 38 is shown retaining the light source 25 with a protective lens 32. The cover 38 can be factory configured or configured onsite for the specific illumination needs. The power supply cover 38 can also function as a heat sink and can be designed to evenly spread the light source 25 heat across the cover's 38 surface. The cover 38 can be formed to include heat dissipating fins 28 (not shown) and the light source's 25 protective lens 32 can have a plurality of optical light pattern distributions. The cover 38 can be detachable with internal “plug 'n play” connector/s to the power supply 22. The cover's 38 surface can be expanded outwardly beyond the walls of the elongated enclosure 19 when more light output is needed.

Along the side walls of the elongated enclosure 19, heat dissipating fins 28 can be formed to accelerate heat removal from the heat generating electrical devices 55 coupled to the elongated enclosure 19. Further, the ribs 18 extending outward perpendicularly to the longitudinal axis of the elongated enclosure 19 can also help in removing the electrical devices'55 generated heat. The ribs 18 are coupled to the elongated enclosure's 19 walls and can externally extend above the elongated enclosure's 19 top surface.

To strengthen the rigidity of the Delta luminaire 1, in at least one embodiment, stiffeners 27 can couple to the ribs 18. The stiffeners 27 and the ribs 18 that extend outwardly from the elongated enclosure 19 can couple to a protective frame 20 at the perimeter of the Delta luminaire 1. The protective frame 20 is a slimline substantially vertical structure that, in at least one embodiment, can have a continuous lip 21 on the interior wall designed to support a PV panel 24. At least two adjacent Delta luminaires can be mechanically coupled to one another by at least one mechanical fastener. In at least one embodiment the mechanical fastener/s can couple the Delta luminaires frame 20. The PV panel's 24 weight can be supported by the lip 21 alone or with the additional support of the at least one of the ribs 18 and/or the stiffeners 27. The PV panel 24 is secured to the Delta luminaire 1 housing structure 50 by mechanical fasteners 31 (not shown).

FIG. 8B shows the same worm eye view perspective of the Delta luminaire 1 as FIG. 8A, with the compartment covers 37, 38, 39 open to the below. Electrical blankets 29 are shown coupled to the bottom face of the PV panel 24. The elements' arrangement of the presently shown truncated arm 26 Delta luminaire 1 can be the same or substantially the same as the extended arm 34 Delta luminaire 1, with the exception of the arm arrangement.

The power supply cover 38 retains a light source 25 on its exterior surface. A conductor 40 can be coupled to the opposite side of the power supply cover 38 that faces the interior of the power supply compartment 43. The conductor 40 can electrically couple the light source 25 retained by the power supply cover 38 to a power supply 22 coupled inside the power supply compartment 43. The conductor 40 can be provided with a quick “plug 'n play” connector. The power supply compartment 43 is sufficiently large to accommodate at least one other power consuming electrical device 55. The electrical device 55, other than the power supply 22, can provide utility to other related and/or non-related services other than illumination.

At the roof of the power supply compartment 43, at least one venting aperture 58 can allow warmed air from inside the compartment 43 to vent to the above. Protected from exposure to water, the venting aperture 58 is disposed below the PV panel 24 and is surrounded by the frame 20 walls of the luminaire 1. The design of the Delta luminaire 1 thermal management provides for air flow across the longitudinal axis of the elongated enclosure 19 above the elongated enclosure 19. Air flowing across the through air gap 33 between the venting aperture 58 disposed at the top surface and the bottom of the PV panel 24 removes the vented heat from the power supply compartment 43.

The triangular device tray 39 provides an enlarged mounting surface area for a plurality of power consuming electrical devices 55. At least two of the coupled electrical devices 55 can have a universal receptacle 23. The receptacle 23 can provide at least one of electrical and data connectivity. An electrical device 55 coupled to the receptacle 23 can be detachable and can be coupled to a knock-out bore in the housing structure 50, based on specific location needs. Inside the device compartment 44, at least one step-down transformer 59 and a power management/controlling device 47 can be coupled.

Electrical thermal blankets 29 shown coupled to the bottom face of the PV panel 24 disposed between the ribs 18 can generate heat to melt snow or ice accumulation on top of the PV panel 24. The electrical thermal blankets 29 receive power from at least one conductor 40 disposed inside the elongated enclosure 19. Electrical thermal blankets 29 can be supplied coupled to the back side of the PV panel 24 having a “plug 'n play” power disconnect 49. The electrical thermal blankets 29 can be activated by at least one of, a sensing device 10 and an input received through a coupled communication device 11.

The ribs 18 of the housing structure 50 can also support additional electrical and/or mechanical devices coupled from below (not shown). The housing structure 50 can be made of metallic material or non-metallic material. The material can be non-corrosive and non-flammable. The housing structure can be formed by at least one of: molding, casting and 3D printing. The housing structure can be painted, anodized, and galvanized.

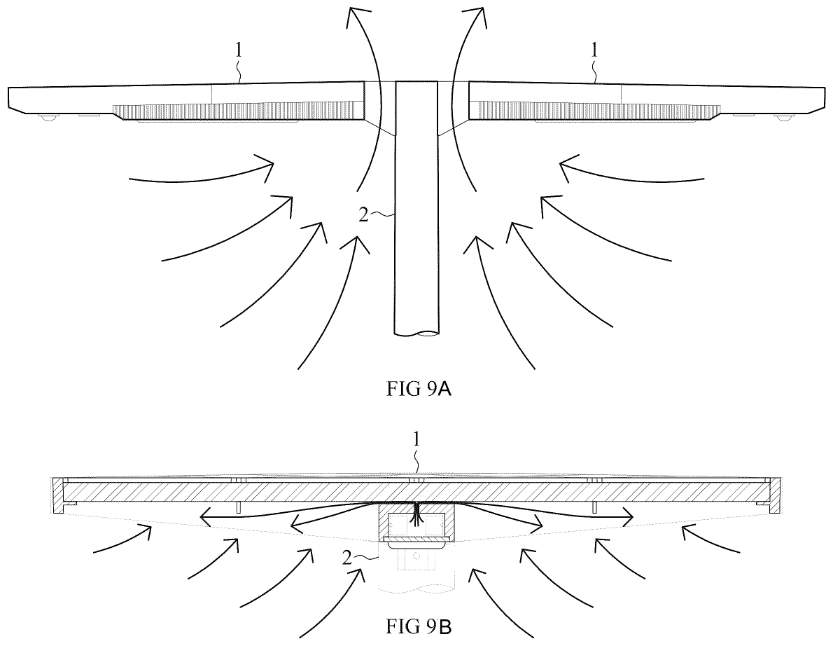

FIGS. 9A and 9B show passive cooling of the Delta luminaire 1. FIG. 9A shows a section through an assembly of Delta luminaires 1 coupled by a truncated arm 26 to a pole 2. FIG. 9B shows a transverse section of the Delta luminaire 1 cross-ventilation.

The present sections show vectors of the air flow inside and around the Delta luminaire 1.

FIG. 9A shows a section through an assembly of truncated arm 26 Delta luminaires 1 mounted on a pole 2. The luminaires' 1 assembly forms a contiguous covered area with through air openings 35 between the luminaires' 1 assembly, the pole 2, and the luminaires' arms 26. During the day the sun warms the PV panels 24 located on top of the luminaire 1. The differential in ambient temperature between the surfaces below and above the luminaire 1 assembly induces cooler air from below to rise and flow through the through air openings to the above. The cooler air flowing from below encounters elements of the housing structure 50 below, resulting in air turbulence. The air turbulence helps remove heat from the coupled electrical devices 55 through the through air openings 35 of the assembly 100.

FIG. 9B shows a transverse section through the Delta luminaire 1. The PV panel 24 is shown distally above the elongated enclosure 19 with a through air gap 33 between. At the bottom of the elongated enclosure 19, a light source 25 coupled to the power supply cover 38 is shown connected to a power supply 22. The power supply 22 is coupled to an inner wall of the elongated enclosure 19. At the roof of the elongated enclosure 19, a venting aperture 58 enables warmed air from inside the power supply compartment 43 of the elongated enclosure 19 to vent through the aperture 58 to the exterior. Cross air flowing between the top of the elongated enclosure 19 and the underside of the PV Panel 24 removes the warmed air.

It is noted that the luminaire's 1 power supply 22, is off during the daytime hours, and the electrical devices 55 are shaded during the day and are removed from direct contact with elements heated by the sun. At night the heat generated by the electrical devices 55 can freely flow to the exterior of the elongated enclosure 19, keeping the coupled electrical devices 55 cool.

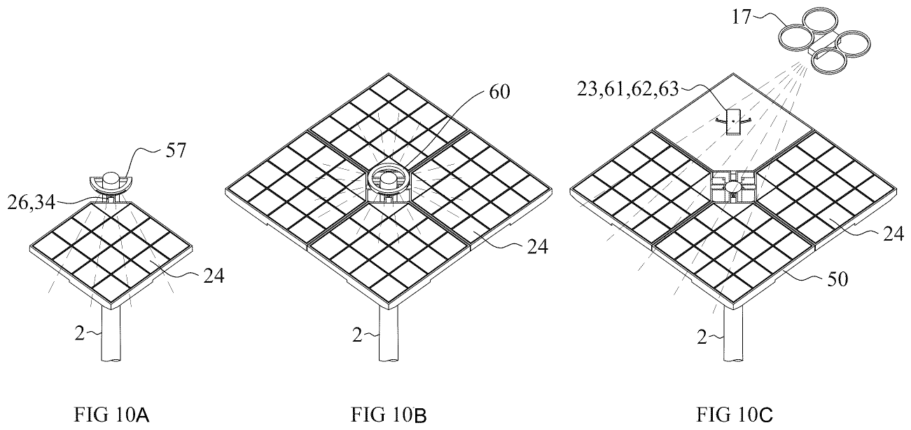

FIGS. 10A, 10B, and 10C show means to prevent dust accumulation on the Delta PV panel. FIGS. 10A and 10B means are coupled to structure, and FIG. 10C is mobile.

The substantially horizontally positioned PV panels 24 are exposed to the elements. The power generation efficiency of the PV panels 24 is diminished by environmental obstructions.

Aside from ice/snow accumulation on the PV panels 24, dust 65 buildup diminishes the panel's 24 power generation capacity. Where dust 65 buildup is prevalent, the Delta luminaire 1 can be coupled to at least two means of dust 65 removal from the top surface of the PV panel 24. One means is a fixed bladeless fan/blower 57,60 and the other is a UAV 17 that can blow air on the panel from above.

FIG. 10A shows a bladeless fan 57 that is coupled to a pole 2 and/or an arm 26, 34 blowing air across the top surface of the Delta PV panel 24. The bladeless fan 57 can have a horizontal or substantially aperture blows air across the PV panel 24, and is configured to direct the air in one or several directions. The direction can include a 90° single spread, back-to-back 90° spreads, a 180° single spread, a 270° single spread, and a 360° single spread.

The center of the streamed air can be aligned with the center of the elongated enclosure 19 (not shown) disposed below the PV panel 24. The bladeless fan's 57 air compressor 58 (not shown) can be distally removed from the pole 2 top and/or the arm 26, 24. In at least one embodiment, the bladeless fan 57 compressor 58 can be inside the power storage and control unit 3 PV device enclosure 5 in proximity to the ground. An air pipe 59 (not shown) originating at the compressor 58 can convey the pressurized air inside the air pipe 59 disposed inside the pole 2 to the outlet aperture/s of the bladeless fan 57.

FIG. 10B shows a centrifugal air blower 60 with fan blades that can force air laterally in at least one direction. The blower 60 coupled to the electrical motor can be placed on at least the pole 2 top with power received from inside the pole 2 from below. Both the bladeless fan's 57 and the centrifugal blower's 60 air can also be warmed to melt ice/snow accumulation.

FIG. 10C shows a UAV 17 coupled to an air fan 64 hovering over a Delta PV panel 24, blowing air over the panel's 24 surface. A UAV 17 such as the one described is described in more detail in the applicant's U.S. Pat. No. 10,215,351, the entire contents of which is incorporated herein by reference. The UAV 17 can dock and receive power from a receptacle 23 on top of a Delta luminaire housing structure 50. The UAV 17 can be programmed and/or instructed by a remote signal to attend to one or several pole 2 mounted PV panels 24 on a single or a plurality of poles 2. The present figure shows the UAV 17 hovering over an assembly of four housing structure 50 panels 24 of the Delta luminaires 1. Three of the housing structures 50 are covered by Delta PV panels 24 and the fourth panel is the docking station 61 of the UAV 17 that includes a homing device 62, a receptacle 23 and a latching device 63.

The substantially horizontal PV panel/s can become a landing and possibly a roosting surface for birds. To circumvent this possibility, the Delta luminaire's pole assembly can employ deterrent devices that can couple to at least one of the pole, the arm, and the Delta luminaire. The deterrent devices can include occupancy sensor/s in combination with air and/or sound emitting devices. The sound emitting devices can be integrated with the air blowing devices and can emit sound when occupancy is sensed on at least one PV panel. The sound emitted can be localized and broadcasted in an inaudible frequency to humans.

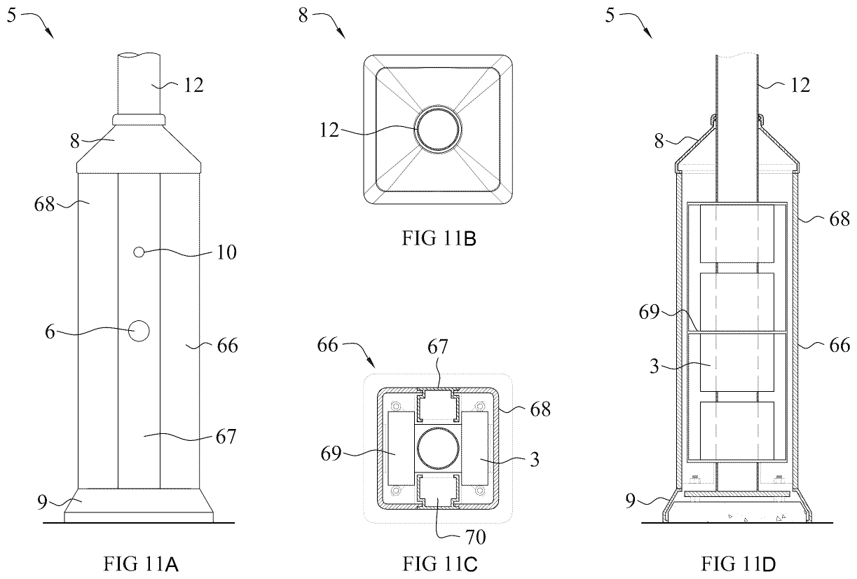

FIGS. 11A, 11B, 11C, 11D show an exemplary ground mounted PV devices enclosure. FIGS. 11A and 11B show front and top views respectively, and FIGS. 11C and 11D show a transverse section and a longitudinal section respectively.

FIG. 11A shows an elevation of the PV devices' enclosure 5. The enclosure 5 can be positioned on grade or elevated above grade. The present embodiment shows the enclosure 5 resting on grade with a pole 12 extending up from the top of the enclosure 5. The enclosure 5 can be comprised of three sections: a power storage and control unit base section 9, a power storage and control unit section 66, and a power storage and control unit cap section 8. These sections can also be referred to as the base, the middle, and the top sections of the PV devices' enclosure 5.

The enclosure's 5 primary function is to secure at least one device of the pole 12 mounted PV power generation system. The enclosure 5 is configured to be accessible for periodic servicing. In addition, at least one device with an unrelated functionality to the power generation PV system and a coupled light source can be electrically, mechanically, or electromechanically coupled to the enclosure. For example, an enclosure placed at a pedestrian crosswalk of a vehicular intersection may include a sensing device 10 and/or a mechanical device that triggers traffic light change when a pedestrian is in the vicinity.

The enclosure shown in the present figure has a base 9, a middle section 66, and a cap 8. The enclosure 5 surrounds a pole 12 with the middle section 66 length being sufficiently long to enclose at least one of, a power storage unit, a processing/control unit, a power management unit, a power conversion device, a switch, a fuse, a lightning arrester, and a surge protector (not shown). As stated above, in addition to the PV power generation devices, other related and non-related devices can be coupled to the enclosure, including at least one of, a sensing device, a communication device, and a security related device (not shown).

The base section 9 of the enclosure 5 can be secured to the pole 12, or pole-based structure. The cap section can be secured to the pole 12. The middle section 66 can have at least one structural extender 67, that extends from the base section 9 of the enclosure 5 to the cap section 8 interlocking the two sections 8, 9. Cabinet cover/s 68 then couple to the structural extender/s 67, concealing from view and protecting the devices inside the enclosure 5. At least one lock 6 can couple the cabinet cover/s 68 to the structural extender/s 67. Once locked in place, the cabinet cover/s 68 is/are configured to resist vandals and thieves. The present innovation shows a location of an electronic keyless lock 6.

The enclosure 5, at least in part, can be fabricated of metallic or non-metallic material. It can also be fabricated, at least in part, of non-corrosive, non-flammable, and non-conductive material. The enclosure's 5 exterior surface can be painted and/or can receive alphanumeric and/or graphic print. The enclosure's 5 surface can be smooth or textured and can have at least one of, a reveal and a protrusion.

FIG. 11B shows a transverse section through a pole showing the top view of the power storage and control unit cap section 8. The cap section 8 can be formed of at least one section. The cap section 8 embraces the pole 12 from all directions, preventing moisture from entering the exterior of the PV device enclosure 5. The cap section 8 can be mechanically fastened to at least one of, the pole and an element of the enclosure 5 below. The diameter and form of the cap section 8 is configured to correspond to the PV device enclosure 5 below. Therefore, the size and the form of the cap section 8 is substantially similar to that of the device enclosure 5.

FIG. 11C shows a transverse section of the PV enclosure 5 midsection 66 below the cap section 8. Two cabinets/shelves 69 are shown coupled to the pole 12. The cabinets/shelves 69 can retain at least one device of the power storage and control unit 3 of the PV power generation system. At opposing sides of the pole, cabinet covers 68 are shown coupled to the structural extender 67. The present figure shows a mechanical key 70 locking the cabinet cover 68 at one end to a structural extender 67, and at the opposite end an electronic lock 6 locking the entire PV device enclosure 5 in place.

FIG. 11D shows a vertical, longitudinal section through the PV device enclosure 5 and the pole 12. From the top down, the section shows the pole 12, the cap section 8 with the cabinet covers 68 in the middle, and the power storage and control unit base section 9 below resting on grade and secured to the concrete pole base. The cabinet/shelf 69 is shown coupled to the pole in front, concealing the pole 12. The cabinet/shelf 69 retains at least one of the PV power storage and control devices 3. The middle section 66 that houses at least one device of the PV power generation system can expand vertically and laterally to accommodate the PV power generation devices' form factor as needed. In addition, the middle section 66 can retain a plurality of non-related devices to the PV power generation system. At least such device can couple to the cabinet covers 68 and/or to the structural extender/s 67.

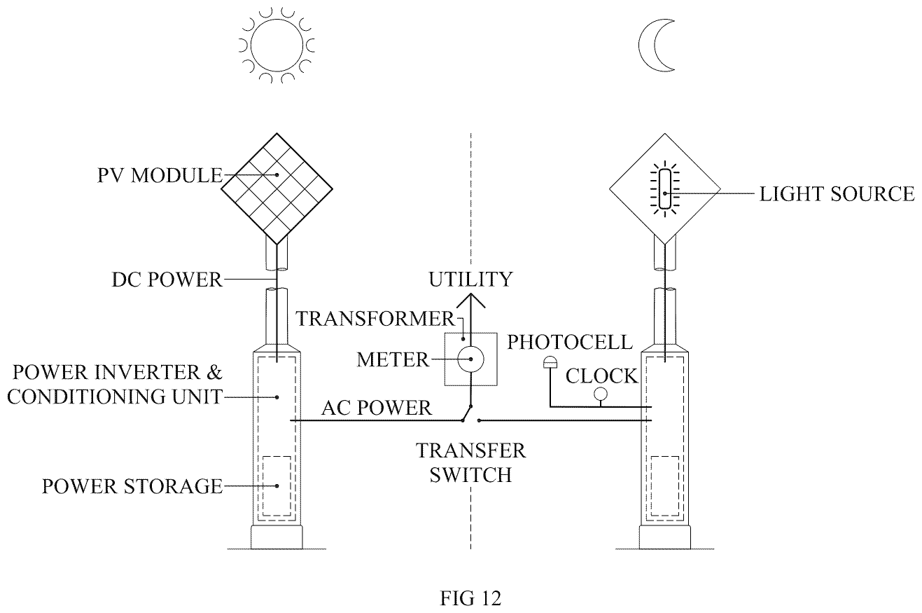

FIG. 12 shows an exemplary day and nighttime power distribution diagram of the pole 2 mounted Delta luminaire 1 with a coupled PV panel 24. The Delta luminaire is powered by at least one of, PV generated power, and power received from the grid. In applications where an ample amount of solar power is available and/or the power demand is negligible, the power source of the light source 25 can be PV generated exclusively.

On the daylight portion of the diagram, the pole 2 mounted PV panel 24 is shown receiving solar radiation and converting the radiation to DC power. The DC power flows from the PV panel 24 to a power inversion and conditioning unit that is preferably mounted below the pole's 2 mid-height. The unit shown in the present diagram is ground 36 mounted. The unit can typically include at least one power storage device 3. The power storage device's 3 storage capacity can vary based on the power management scheme of the pole 2 mounted luminaire.

The present diagram shows a power generating system with a capacity to transmit power to remote users through the grid. In at least one scenario, during daytime hours when the power storage device 3 reaches maximum capacity, the excess power can be released to the grid. The excess power can be regulated, filtered, and converted to AC power. A transfer switch can switch between the pole 2 mounted Delta luminaire 1 and/or other electrical devices 55, and external power transmission to the grid. The power transmission to the grid can be metered 60 in both directions.

Since the cost of power is lower at night, another power management scheme can transmit all or most of the PV power harvested during the daylight hours to the grid, and at night draw at least a portion of the power from the grid. This power management scheme can reduce or eliminate the need for power storage devices 3; however, it is not recommended for use in localities subject to frequent power interruptions, localities with extensive cloud cover, and/or unpredictable weather.

At dusk the luminaire's 1 light source 25 turns on by at least one of, a photocell 54, an astronomical clock 61, and by a command signal received from a remote location. The light source 25 can receive power from only one power source at a time. However, a different circuit other than the light source 25 dedicated circuit can electrify other power consuming electrical devices 55 coupled to the pole 2. At or before dawn the luminaire's 2 light switched off. The luminaire's 1 light can turn off by photocell 54, a clock, and by a command signal received from a remote location.

The power management system can include at least one processor 12 with resident memory and code that can control the operation of the light source 25. The light source 25 can be turned on, off and dimmed. Further, sensing 10 and communication 11 devices coupled to a plurality of PV powered poles 2 with a processor 12 governing at least the lighting of the pole's 2 operation can add predictive operational parameters. For example, along a straight road a pole 2 coupled to a sensing device 10 and a communication device 11 can alert and/or direct other pole 2 mounted luminaires 1 ahead to turn on when a vehicle traveling in the direction of the poles 2 is sensed.

The control methods and systems described herein may be implemented using computer programming or engineering techniques including computer software, firmware, hardware or any combination or subset thereof, wherein the technical effects may include at least control operations for a self-powered roadway luminaire using PV.

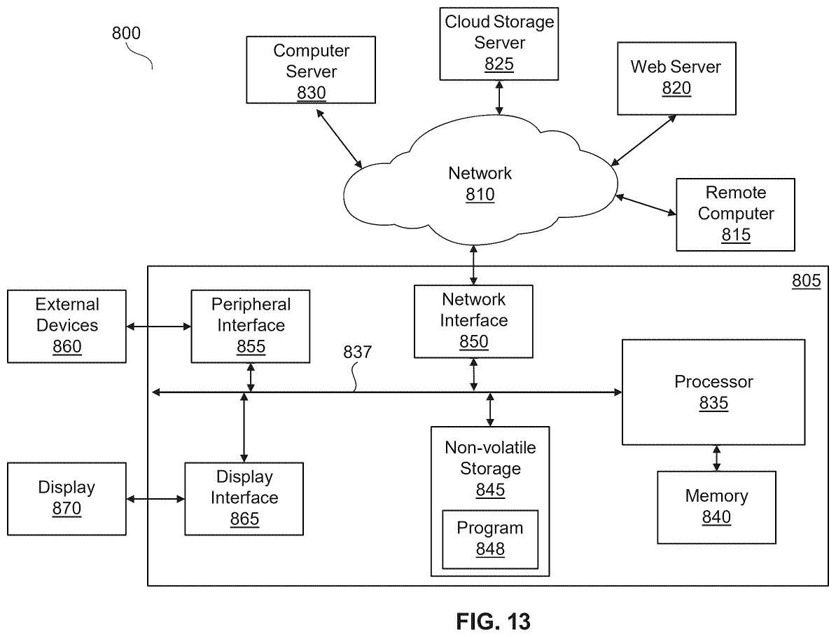

FIG. 13 illustrates a block diagram of a computer that may implement the various embodiments described herein.

The control aspects of the present disclosure may be embodied as a system, a method, and/or a computer program product. The computer program product may include a computer readable storage medium on which computer readable program instructions are recorded that may cause one or more processors to carry out aspects of the embodiment.

The computer readable storage medium may be a tangible device that can store instructions for use by an instruction execution device (processor). The computer readable storage medium may be, for example, but is not limited to, an electronic storage device, a magnetic storage device, an optical storage device, an electromagnetic storage device, a semiconductor storage device, or any appropriate combination of these devices. A non-exhaustive list of more specific examples of the computer readable storage medium includes each of the following (and appropriate combinations): flexible disk, hard disk, solid-state drive (SSD), random access memory (RAM), read-only memory (ROM), erasable programmable read-only memory (EPROM or Flash), static random access memory (SRAM), compact disc (CD or CD-ROM), digital versatile disk (DVD) and memory card or stick. A computer readable storage medium, as used in this disclosure, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described in this disclosure can be downloaded to an appropriate computing or processing device from a computer readable storage medium or to an external computer or external storage device via a global network (i.e., the Internet), a local area network, a wide area network and/or a wireless network. The network may include copper transmission wires, optical communication fibers, wireless transmission, routers, firewalls, switches, gateway computers and/or edge servers. A network adapter card or network interface in each computing or processing device may receive computer readable program instructions from the network and forward the computer readable program instructions for storage in a computer readable storage medium within the computing or processing device.

Computer readable program instructions for carrying out operations of the present disclosure may include machine language instructions and/or microcode, which may be compiled or interpreted from source code written in any combination of one or more programming languages, including assembly language, Basic, Fortran, Java, Python, R, C, C++, C# or similar programming languages. The computer readable program instructions may execute entirely on a user's personal computer, notebook computer, tablet, or smartphone, entirely on a remote computer or computer server, or any combination of these computing devices. The remote computer or computer server may be connected to the user's device or devices through a computer network, including a local area network or a wide area network, or a global network (i.e., the Internet). In some embodiments, electronic circuitry including, for example, programmable logic circuitry, field-programmable gate arrays (FPGA), or programmable logic arrays (PLA) may execute the computer readable program instructions by using information from the computer readable program instructions to configure or customize the electronic circuitry, in order to perform aspects of the present disclosure.

Aspects of the present disclosure are described herein with reference to flow diagrams and block diagrams of methods, apparatus (systems), and computer program products according to embodiments of the disclosure. It will be understood by those skilled in the art that each block of the flow diagrams and block diagrams, and combinations of blocks in the flow diagrams and block diagrams, can be implemented by computer readable program instructions.

The computer readable program instructions that may implement the systems and methods described in this disclosure may be provided to one or more processors (and/or one or more cores within a processor) of a general purpose computer, special purpose computer, or other programmable apparatus to produce a machine, such that the instructions, which execute via the processor of the computer or other programmable apparatus, create a system for implementing the functions specified in the flow diagrams and block diagrams in the present disclosure. These computer readable program instructions may also be stored in a computer readable storage medium that can direct a computer, a programmable apparatus, and/or other devices to function in a particular manner, such that the computer readable storage medium having stored instructions is an article of manufacture including instructions which implement aspects of the functions specified in the flow diagrams and block diagrams in the present disclosure.

The computer readable program instructions may also be loaded onto a computer, other programmable apparatus, or other device to cause a series of operational steps to be performed on the computer, other programmable apparatus or other device to produce a computer implemented process, such that the instructions which execute on the computer, other programmable apparatus, or other device implement the functions specified in the flow diagrams and block diagrams in the present disclosure.

FIG. 13 is a functional block diagram illustrating a networked system 800 of one or more networked computers and servers. In an embodiment, the hardware and software environment illustrated in FIG. 13 may provide an exemplary platform for implementation of the software and/or methods according to the present disclosure.

Referring to FIG. 13, a networked system 800 may include, but is not limited to, computer 805, network 810, remote computer 815, web server 820, cloud storage server 825 and computer server 830. In some embodiments, multiple instances of one or more of the functional blocks illustrated in FIG. 13 may be employed.

Additional detail of computer 805 is shown in FIG. 13. The functional blocks illustrated within computer 805 are provided only to establish exemplary functionality and are not intended to be exhaustive. And while details are not provided for remote computer 815, web server 820, cloud storage server 825 and computer server 830, these other computers and devices may include similar functionality to that shown for computer 805.

Computer 805 may be a personal computer (PC), a desktop computer, laptop computer, tablet computer, netbook computer, a personal digital assistant (PDA), a smart phone, or any other programmable electronic device capable of communicating with other devices on network 810.

Computer 805 may include processor 835, bus 837, memory 840, non-volatile storage 845, network interface 850, peripheral interface 855 and display interface 865. Each of these functions may be implemented, in some embodiments, as individual electronic subsystems (integrated circuit chip or combination of chips and associated devices), or, in other embodiments, some combination of functions may be implemented on a single chip (sometimes called a system on chip or SoC).

Processor 835 may be one or more single or multi-chip microprocessors, such as those designed and/or manufactured by Intel Corporation, Advanced Micro Devices, Inc. (AMD), Arm Holdings (Arm), Apple Computer, etc. Examples of microprocessors include Celeron, Pentium, Core i3, Core i5 and Core i7 from Intel Corporation; Opteron, Phenom, Athlon, Turion and Ryzen from AMD; and Cortex-A, Cortex-R and Cortex-M from Arm.

Bus 837 may be a proprietary or industry standard high-speed parallel or serial peripheral interconnect bus, such as ISA, PCI, PCI Express (PCI-e), AGP, and the like.

Memory 840 and non-volatile storage 845 may be computer-readable storage media. Memory 840 may include any suitable volatile storage devices such as Dynamic Random Access Memory (DRAM) and Static Random Access Memory (SRAM). Non-volatile storage 845 may include one or more of the following: flexible disk, hard disk, solid-state drive (SSD), read-only memory (ROM), erasable programmable read-only memory (EPROM or Flash), compact disc (CD or CD-ROM), digital versatile disk (DVD) and memory card or stick.

Program 848 may be a collection of machine readable instructions and/or data that is stored in non-volatile storage 845 and is used to create, manage and control certain software functions that are discussed in detail elsewhere in the present disclosure and illustrated in the drawings. In some embodiments, memory 840 may be considerably faster than non-volatile storage 845. In such embodiments, program 848 may be transferred from non-volatile storage 845 to memory 840 prior to execution by processor 835.

Computer 805 may be capable of communicating and interacting with other computers via network 810 through network interface 850. Network 810 may be, for example, a local area network (LAN), a wide area network (WAN) such as the Internet, or a combination of the two, and may include wired, wireless, or fiber optic connections. In general, network 810 can be any combination of connections and protocols that support communications between two or more computers and related devices.

Peripheral interface 855 may allow for input and output of data with other devices that may be connected locally with computer 805. For example, peripheral interface 855 may provide a connection to external devices 860. External devices 860 may include devices such as a keyboard, a mouse, a keypad, a touch screen, and/or other suitable input devices. External devices 860 may also include portable computer-readable storage media such as, for example, thumb drives, portable optical or magnetic disks, and memory cards. Software and data used to practice embodiments of the present disclosure, for example, program 848, may be stored on such portable computer-readable storage media. In such embodiments, software may be loaded onto non-volatile storage 845 or, alternatively, directly into memory 840 via peripheral interface 855. Peripheral interface 855 may use an industry standard connection, such as RS-232 or Universal Serial Bus (USB), to connect with external devices 860.

Display interface 865 may connect computer 805 to display 870. Display 870 may be used, in some embodiments, to present a command line or graphical user interface to a user of computer 805. Display interface 865 may connect to display 870 using one or more proprietary or industry standard connections, such as VGA, DVI, DisplayPort and HDMI.

As described above, network interface 850, provides for communications with other computing and storage systems or devices external to computer 805. Software programs and data discussed herein may be downloaded from, for example, remote computer 815, web server 820, cloud storage server 825 and computer server 830 to non-volatile storage 845 through network interface 850 and network 810. Furthermore, the systems and methods described in this disclosure may be executed by one or more computers connected to computer 805 through network interface 850 and network 810. For example, in some embodiments the systems and methods described in this disclosure may be executed by remote computer 815, computer server 830, or a combination of the interconnected computers on network 810.

Data, datasets and/or databases employed in embodiments of the systems and methods described in this disclosure may be stored and or downloaded from remote computer 815, web server 820, cloud storage server 825 and computer server 830.

Circuitry as used in the present application can be defined as one or more of the following: an electronic component (such as a semiconductor device), multiple electronic components that are directly connected to one another or interconnected via electronic communications, a computer, a network of computer devices, a remote computer, a web server, a cloud storage server, a computer server. For example, each of the one or more of the computer, the remote computer, the web server, the cloud storage server, and the computer server can be encompassed by or may include the circuitry as a component(s) thereof. In some embodiments, multiple instances of one or more of these components may be employed, wherein each of the multiple instances of the one or more of these components are also encompassed by or include circuitry. In some embodiments, the circuitry represented by the networked system may include a serverless computing system corresponding to a virtualized set of hardware resources. The circuitry represented by the computer may be a personal computer (PC), a desktop computer, a laptop computer, a tablet computer, a netbook computer, a personal digital assistant (PDA), a smart phone, or any other programmable electronic device capable of communicating with other devices on the network. The circuitry may be a general purpose computer, special purpose computer, or other programmable apparatus as described herein that includes one or more processors. Each processor may be one or more single or multi-chip microprocessors. Processors are considered processing circuitry or circuitry as they include transistors and other circuitry therein. The circuitry may implement the systems and methods described in this disclosure based on computer-readable program instructions provided to the one or more processors (and/or one or more cores within a processor) of one or more of the general purpose computer, special purpose computer, or other programmable apparatus described herein to produce a machine, such that the instructions, which execute via the one or more processors of the programmable apparatus that is encompassed by or includes the circuitry, create a system for implementing the functions specified in the flow diagrams and block diagrams in the present disclosure.

Alternatively, the circuitry may be a preprogrammed structure, such as a programmable logic device, application specific integrated circuit, or the like, and is/are considered circuitry regardless if used in isolation or in combination with other circuitry that is programmable, or preprogrammed.

### Overview of Embodiment With Bifurcated Positioning of Devices on Vertical Structure Based on Expected Service Time

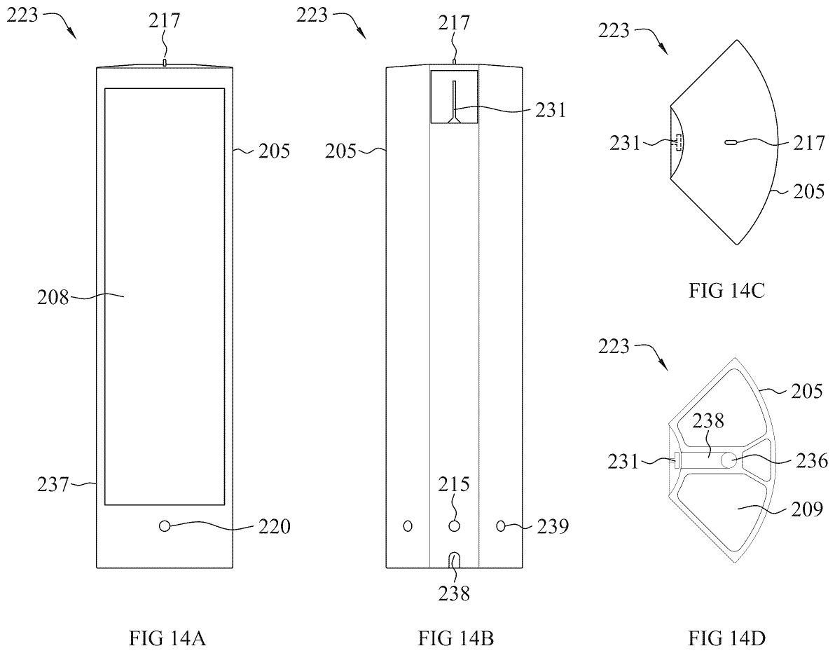

The following is a brief summary of aspects of the system and structures described in FIGS. 14-21. A more detailed description follows in the next section of this paper. A PV pole's 210 short-lived/heavy weight components of the current application are housed in at least one enclosure. In this context “short-lived” is a relative term and made with respect to the expected service times of longer-lived parts disposed higher on the PV pole. Example expected service times of the “short-lived” components may be expressed in terms of mean-time-between-failure (MTBF), and may range from 75,000 hours or less, with more typical MTBFs being 50,000 hours or less. These “short-lived” components are short-lived with respect to the “longer-lived” components which have higher MTBFs that the devices installed lower on or near the PV pole.

An enclosure is referred to herein as the inverter's pod 223. The PV pole 210 can employ one or several inverter pods 223. The inverter pod 223 can be located at or above grade. The inverter's pod 223 is an elongated vertical structure that is configured to directly and/or indirectly couple to the PV pole 210. An inverter pod 223 assembly can comprise several inverter pods 223 arranged around the PV pole's 210 vertical axis.

For example, in at least one urban setting where a PV pole assembly 200 is embedded in a street sidewalk, the bottom surface of the inverter's pod/s 223 is set at 8-10 ft above grade. The reason for the pod/s' elevated placement includes keeping the heavy components coupled to the PV pole assembly 200 at a lower height to minimize stress and torque on the pole, making the inverter pod/s 223 easily accessible for service while removing potential visual obstruction. It is noted that in an assembly of inverter pods 223, at least one inverter pod 223 retains an inverter. Other inverter pods 223 can retain other components configured to operate at least in part with the at least one inverter.

In a different urban setting such as an on-grade parking facility, in addition to providing illumination, the PV pole 210 can provide power to EV's. In this setting, power plug-in cable dispenser/s 228 can extend down from elevated inverter pod/s 223. Placing the inverter pod/s 223 overhead enables vehicles to reach closer to the PV pole 210 giving the power cable/s greater latitude about the PV pole 210. In addition, by having the inverter pod/s 223 elevated, a predator cannot hide behind a grade mounted enclosure, thus the inverter pod/s' 223 elevated placement is safer. By contrast, along a highway where risks of vandals, thieves, and/or predators are minimal, the inverter pod/s 223 can be located on or in proximity to grade making access to the pod's 223 internal components easier.

The parent application focused on elements coupled to the PV's pole top. The present application focuses on solutions for integrating inverter pod/s 223 that house at least one short-lived heavy component on a PV pole 210. It is noted that the components coupled to at least one inverter pod 223 and the PV pole 210 can include at least one inverter, a power storage device, a surge suppressor, a shutoff switch, a processor, a communication device, a sensing device 226, a power output device, a receptacle, a push/reset button, a human interface, a metering device, a hand hole cover 234, an indicator light 229, a battery, an inverter, a switch, a processor, a communication device, an antenna 236, and an EV charging plug-cable dispenser 228 with or without a hoisting apparatus.

The inverter pod 223 coupled to a PV pole 210 can be configured to include a component assembly that enables storing PV power collected during day hours. The power collected can be dispensed upon generation and/or can be dispensed when needed. The power generated can be consumed by the PV pole 210 coupled device and/or can be transmitted to a remote user via an external power grid. It is noted that a plurality of modular pods 223 can be coupled to the PV pole 210, wherein each pod 223 can contain a portion of or all the components needed to at least convert power, store power, and transmit power to a PV pole 210 mounted device and/or to a remote user as needed.

The modular inverter pod's 223 elongated form is configured to couple to the PV pole's 210 vertical structure. A single or a plurality of inverter pods 223 coupled to a PV pole 210 can provide a counterweight to elements mounted at the pole's top. The inverter pod/s' 223 weight and placement on the pole can reduce moment and torque stresses acting on the PV pole 210. The inverter pod/s' 223 access door/s 208 can be at the opposite side of the pod's 223 surface facing the pole 210. Power connectivity from the PV pole 210 can be from the inverter pod's 223 bottom surface and/or from a vertical side surface of the inverter's pod 223. The access door/s 209 of the inverter pod 223 can have a door lock 220. The door lock 220 can be an electronic lock. To gain access to a pod 223 interior, the access code to the pod's door lock 220 can be communicated from remote. The code can be time sensitive and expires after the allotted time.

The design of the elongated inverter pod housing 205 can be configured to utilize small form factor advanced technology components. New classes of small form factor batteries with significantly high power density are on the cusp of replacing legacy lead calcium battery technology used by the PV industry. These new battery technology classes currently provide storage for primarily AI computing devices and for the EV industries. Nonetheless, as with other electronic devices' cost trajectory, the new battery technology cost is expected to erode, making the new technology affordable for at least PV power storage. For example, the Enovix battery (e.g., a high-performance, lithium-ion (Li-ion) battery that uses a 3D architecture and a 100% silicon anode) can have an elongated reduced form, can display significantly higher power density when evaluated against its peers, and can show gradual and controlled power release over an extended time. The performance characteristics are compatible with the needs for the PV industry's various applications for power storage devices.

At the beginning portion of this application (with reference to FIGS. 1-13) there is described a light emitting device integrated with a PV panel. The assembly described is scalable for both the light source 201 and the PV panel 203. In at least one embodiment, up to four pole mounted arms 233 with integrated light sources/luminaires 201 and PV panels 203 coupled from above couple to a PV pole 210 at or in proximity to the pole 210 top. The assembly described including the PV panel 203, the support arm 233, and the integrated to the arm light source/luminaire 201 can be scaled up as needed. The PV panel 203 couples to the arm 233 with the integrated light source/luminaire along the diagonal axis of the PV panel 203. The above described assembly is modular and is associated with long-lived generally light weight PV pole top mounted electromechanical devices.

The inverter pod 223 assembly mounted to the PV pole 210 below the PV pole 210 top assembly can comprise at least one heavy and/or short-lived device and can be configured to be modular. The modular inverter pod 223 can be configured to be communicatively electrically coupled to a corresponding PV panel 203. The PV panel can be coupled to an arm 233 with an integrated light source/luminaire 201. In at least one different embodiment, a plurality of pole mounted PV panel arms 233 with light sources/luminaires 201 can each be communicatively electrically coupled to a reciprocating inverter pod 223. In yet a different embodiment of the above arrangement, at least one of the inverter pods 223 can be configured to provide generated power to a coupled light source/luminaire 201 while the balance of the power is transmitted to a different power consuming device, or to at least one power consuming device other than a light source/luminaire 201.

In yet a different embodiment, at least one inverter pod 223 can be communicatively electrically coupled to an adjacent inverter pod 223, wherein power received by the inverter pod 223 is generated by at least two PV panels 203. At least one inverter pod's 223 power can be partially or fully transmitted to an external user client. The inverter pod housing 205 can be fabricated of non-corrosive material and can be configured to be at least thermally protected, fire resistant, and moisture resistant. In at least one embodiment the inverter pod housing 205 can be configured to have at least one air breather 215.

The inverter pod 223 can be coupled and dedicated to a single or to a plurality of PV light panels 203. The inverter pod 223 coupled electrical devices can include at least one inverter, a battery, AC disconnect, DC disconnect, a sub-panel, a processor/controller with code, a communication device, a sensing device, a switching device, a surge suppressor, a meter, a human interface, a speaker, a EV charger, an indicator device, a lock, and a mounting fitting/harness that is mechanically or electromechanically coupled to a PV pole. The devices coupled to the inverter pod 223 can be sized to correspond to the power demand and/or the power supply of the at least the PV pole light source 201 and/or the devices electrically coupled PV panel/s 203.

The at least one inverter pod 223 coupled to a PV pole 210 can be configured to receive DC power from a PV power generation panel 203 positioned in an elevated location on a PV pole 210. The power generated can be stored in a power storage device as a battery inside an inverter pod 223 or directly routed to at least one power consuming device. The power stored by the power storage unit can be used at any time based on need/s. Aside from powering a light source/luminaire 201 coupled to the PV pole assembly 200, power from the power storage unit can power at least one power consuming device coupled to the PV pole 210 and/or a power consuming device external to the PV pole 210. The power conveyed to and from the inverter pod 223 can be AC and DC. Power traveling from and to the power consuming and generating devices concealed from view, at least in part, inside and outside the PV pole assembly 200.

In addition, other power consuming devices can be electrically or electrically and communicatively coupled to the inverter pod 223. At least one of these devices can be located below or above the inverter pod 223. These devices can be coupled to the PV pole's 210 interior or exterior surfaces. Other devices can be coupled to the inverter pod's 223 exterior surface. For example, a power receptacle or a crosswalk push button can couple to a PV pole's 210 exterior below the inverter pod 223. For example, a traffic light signal 240 can couple to the PV pole's 210 exterior surface above the inverter pod 223. An example of a device extending down from an inverter pod 223 can be an EV power plug dispenser 228, a sensor 226, and/or an indicator light 229. It is noted that the array of devices coupled to the inverter pod 223 and the inverter pod 223 height above grade is determined, at least in part, by the PV pole's 210 specified functional utility and the surrounding environment where the PV pole 210 is placed.

The inverter pod's 223 modular design is configured to provide utility for a specific environment. The power or power and communication connectivity between the modular inverter pod 223 device assembly to the PV pole 210 power or power and communication devices can be “Plug 'N Play”. Rather than maintaining a failed short-lived component at the PV pole 210 location, servicing an inverter pod 223 can take place by quicky replacing a failed inverter pod 223 with a replacement inverter pod 223. The failed inverter pod 223 can then be hauled to a service shop for repair. This service protocol minimizes onsite prolonged service calls that may disrupt vehicular and/or pedestrian traffic and may increase safety risks. Further, on average trouble shooting an issue on site typically takes longer and occasionally requires more than one service trip.

To enable a quick inverter pod 223 replacement, the PV pole 210 can be fitted with mechanical or electromechanical connectivity provisions. For example, a PV pole assembly 200 retaining four inverter pods 223 can have the inverter pods' 223 arrangement position at 90° to one another about the vertical axis of the PV pole 210. Each inverter pod 223 can have at least one power or power and communication entry bore/opening 236 at a bottom and/or a side surface of the inverter pod housing 205. The entry bore/opening 236 can be threaded configured to couple to at least a mechanical or an electromechanical support arm 202 or be smooth faced. The means of providing mechanical support for an inverter pod 223 and power connectivity may vary. To maintain installation and servicing simplicity, incorporating power and communication to the inverter pod's 223 mechanical support is preferred. The mechanical connector can be configured to also provide moisture protection preventing moisture travel into the inverter pod 223 and to the PV pole 210.

In at least one embodiment, at least one factory or field installed electromechanical support arm 202 can be coupled to the PV pole 210. A pole strap 207 coupled to a leader bracket 206 can be installed above and oriented to align with the electromechanical support arm 202. The leader bracket's 206 mounting height is configured in relation to the height of the inverter pod 223 to be coupled. The inverter pod 223 can then be lowered from above engaging a male leader coupled to a pole flanged bracket in the pod's guiding track 231 onto the electromechanical support arm 202. A through bore 236 at the bottom surface of the inverter pod 223 is configured to receive the electromechanical support arm 202. The electromechanical support arm 202 extension that is configured to enter the interior of the inverter pod housing 205 can then be secured mechanically including provisions for moisture protection. It is noted that the electromechanical support arm 202 that supports the weight of the inverter pod 223 can include reciprocating electrical and communication connectors inside the inverter pod housing 205 to enable quick “Plug 'N Play” connectivity.

### Detailed Description of Embodiment With Bifurcated Positioning of Devices on Vertical Structure Based on Expected Service Time

The inverter pod is a general descriptor of power consuming devices that are housed in or in and on the inverter pod housing. The inverter pod housing couples to a PV pole. A single PV pole can support a plurality of inverter pods. The inverter pods can be arranged around the exterior surface of at least the PV pole. The inverter pod housing can vary in height. The height of the inverter pod housing is configured in relation to the equipment it houses.

At least one of the pluralities of inverter pods that are coupled to the PV pole houses an inverter. At least one inverter can be electrically coupled to an adjacently coupled inverter. At least one of the inverter pods that are coupled to the PV pole houses a short-lived electrical device. A short-lived electrical device's effective life rating through calendar year 2035 is 50,000 hrs. Beyond calendar year 2035 the effective life rating of a short-lived electrical device can be extended to no greater than 75,000 hrs.

FIG. 14A shows the front view of the inverter pod 223. Access to the inverter pod 223 interior is gained by removing the access door 205. The access door can be secured to the inverter pod housing by a lock 220. The lock 220 can be electronic requiring time sensitive code. For service, the access door 208 removed from the door frame 237 can be coupled to the housing by an extension wire. The access door frame 237 can include gasketing for moisture protection. The elements shown include the inverter pod housing 205, a pod lifting harness/loop 217, an access door 208, a door lock 220, and a door frame 237.

FIG. 14B shows the back and side views of the inverter pod 223. The back side of the inverter pod housing 205 couples to the PV pole 210. In at least one embodiment, the elongated vertical pod housing 205 rests at its bottom end on a mechanical or electromechanical support arm. The present figure shows a recess 238 in the inverter pod housing 205 configured to conceal the electro/mechanical support arm from view. In proximity to its top end, the pod housing 205 is secured to the PV pole by a pod guiding track 231. The elements shown include the inverter pod housing 205, a pod lifting harness/loop 217, an electro/mechanical support arm recess 238, a pod guiding track 231, pod side coupler opening 239, and a breather 215.

FIG. 14C shows the top view of the inverter pod 223. The inverter pod housing 205 can be lowered into position by engaging a flanged bracket male leader that is coupled to a pole inside a female guiding track 231. A pod lifting harness/loop 217 is shown on top of the inverter pod housing 205. The inverter pod housing can have a built-in slope to remove moisture and avoid ice built-up. On the sloped surface at least one repelling device can be placed to prevent birds from nesting. The elements shown include the inverter pod housing 205, a pod lifting harness/loop 217, and the pod guiding track 231.

FIG. 14D shows the bottom view of the inverter pod 223. The inverter pod housing can rest on an electro/mechanical support arm. The present figure shows a recess 238 that is configured to receive said support arm. At three sides surrounding the recess 238 compartment covers 209 shown are configured to cover and/or couple to a plurality of sensing and/or output devices. The pod guiding track 231 is shown coupled to the inverter pod housing at the housing's side that faces the PV pole. The elements shown include the inverter pod housing 205, an electromechanical support arm recess 238, a component cover 209, the pod guiding track 231, and an entry bore opening 236.

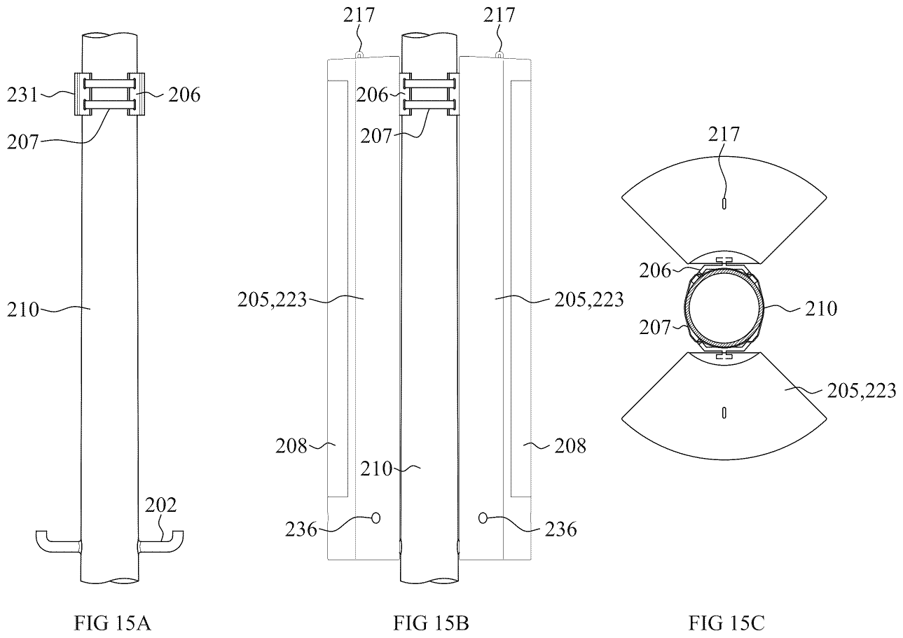

FIGS. 15A, 15B, and 15C show side (FIGS. 15A and 15B) and top views (FIG. 15C) of PV pole sections retaining an inverter pod.

FIG. 15A shows a partial elevation of a round tapered PV pole 210 section that is configured to support at least two inverter pods 223. Toward the bottom of the elevation two mechanical support arms 202 positioned at opposite sides of the pole's section extend outward. Above and vertically aligned with the mechanical support arms 202 corresponding flange brackets 206 are shown coupled to the PV pole 210 section by pole straps 207. At least one pod guiding track 231 is coupled to the flange bracket 206. The inverter pod housing (not shown) is configured to be lowered from above guided through and by the pod guiding tracks 231. In the at least the present embodiment, the inverter pod housing rests on the mechanical support arm 202. The mechanical support arm 202 can provide either mechanical support or electromechanical support and connectivity. Elements shown include a PV pole 210 section, a mechanical or electromechanical support arm 202, a pole strap 207, and a flange bracket 206 with a guiding track 231.

FIG. 15B shows an elevation of the PV pole section 210 with two inverter pods 223 coupled from opposite sides. The mechanical support arms, concealed from view, can have an upward extension that is configured to either couple to the inverter pod's bottom surface or enter into the interior space of the inverter pod housing 205. The latter method is used with electromechanical support arm connectivity. The inverter pod's 223 vertical central axis is configured to substantially or fully align with the PV pole's 210 vertical axis. For this reason, the distal distance of the support arm extension, the alignment between the support arm and the male leader 204 of the flanged bracket 206, and the height of the flanged bracket 206 above the at least mechanical support arm 202 are critical for sound installation. The elements shown include a PV pole section 210, an inverter pod 205, 223, an inverter pod access door 208, a coupler opening/bore, and an inverter pod lifting harness/loop 217.

FIG. 15C shows a horizontal section through a PV pole 210 with a view to the below. The figure shows two vertical inverter pods 223 positioned at opposite sides of the PV pole 210. The inverters pods 223 are coupled to the PV pole 210 flanged brackets 206 with pole straps 207. A lifting harness/loop shown on top of the pod enables lifting/lowering the inverter pod housing 205 into/from its installation position. The elements shown include the PV pole 210, the inverter pod 223, the inverter pod housing 205, the flanged bracket 206, pole straps 207, the lifting harness/loop 217, and the top view of the pod's guiding track 231.

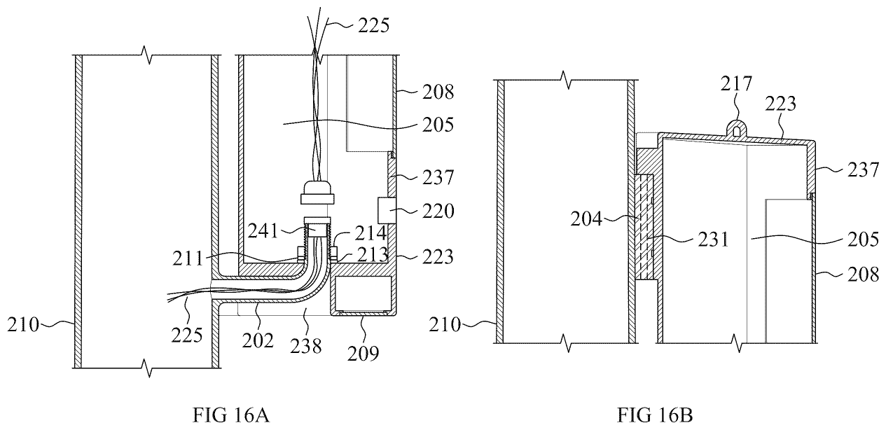

FIGS. 16A and 16B show partial vertical cross-sections of an inverter pod housing supported by an electromechanical arm and a bracket flange respectively to a PV pole.

FIG. 16A shows the bottom portion of the inverter pod 223 connection to the PV pole 210. The figure shows a welded “L” shaped tubular structure welded at one end to a partial section of a PV pole 210 wall. At the opposite end of the “L” shaped structure, a vertical extension of the structure is shown entering the bottom of the inverter pod housing 205 through an entry bore/opening 236. The inverter pod 223, 205 shown is configured to rest on the “L” shaped structure referred to herein as the mechanical support arm 202. The mechanical support arm can provide mechanical support only or can provide mechanical support and electrical connectivity. The present embodiment shows an exemplary electromechanical support arm 202.

As a system configured to be modular, the support arm 202 with its upward extending portion is configured to be precisely located at a specified distance from the PV pole's 210 exterior surface that corresponds to an entry core/opening located at the bottom surface of the inverter pod housing 205. In addition, the electromechanical support arm 202 must vertically co-align with a PV pole 210 coupled flanged bracket 206 that couples the pod's female guiding track 231 above. It is noted that the electromechanical support arm 202 connectivity to the PV pole can be at least by one of a weld, thread, and bolt, or a combination thereof.

The electromechanical support arm 202 shown in the inverter pod housing 205 is recessed inside the electromechanical support arm recess 238. The recess 238 is an architectural feature configured to conceal the electromechanical support arm 202 from direct view. At opposite sides of the recess 238 walls, several compartments covered by compartment covers 209 are shown. Power consuming and/or power conveying devices can be coupled to the compartment covers and/or housed inside the compartment/s. At least one sensing, output, and power conveyance conductor/s can be coupled to the compartment/s cover 209. The compartment cover 209 can be secured to the inverter pod housing by screws/fasteners and the compartments' interior can be moisture proofed.

The present electromechanical support arm 202 embodiment shows a tubular arm configured to convey at least one of power and signal to and from the inverter pod housing 205. The PV pole 210 can be configured to generate its own power and can be isolated from an exterior power grid, or can be connected to an exterior power grid. Power flowing to and from the inverter pod 223 can be configured to travel inside or inside and outside the PV pole 210 and in at least one embodiment beyond the PV pole assembly 200. Conductors originating from inside the PV pole 210 can extend through the electromechanical support arm 202 and terminate in a receptacle embedded in the top portion of the support arm's 202 vertical extension.

The electromechanical support arm's 202 vertical extension entering the inverter's housing 205 can provide several utilities. In at least one embodiment as shown in the present figure, the electromechanical support arm's 202 vertical extension can have a threaded exterior surface. To provide mechanical and moisture protection, the portion of the support arm's 202 vertical extension inside the inverter's pod housing 205 can be used to secure the electromechanical support arm 202 to the inverter pod housing 205. After removing the access door 208, an installer can secure the assembly by securing a nut with a washer and a gasket below to the threaded arm's threaded vertical extension.

In addition, the modular inverter pod 223 electrical componentry can be delivered fully assembled with a wiring harness that terminates with a plug-in receptacle. A corresponding receptacle can be coupled to the top end of the vertical extension of the electromechanical support arm 202. As described above, the exterior surface of the vertical extension of the electromechanical support arm 202 can be threaded. It is noted that for quick connectivity, a “Plug 'N Play” reciprocating receptacle can connect the electrical component assembly wiring harness to the electrical conductors conveyed through the electromechanical support arm 202 by securing receptacle connectors to the threaded arm extension.

The elements shown include a PV pole 210, an electromechanical support arm 202, a gasket 213, a washer 211, a nut 214, a receptacle, a conductor 225, an inverter pod and housing 223, 205, an access door 208, a compartment cover 209, and an electromechanical support arm recess 238.

FIG. 16B shows the top portion of the inverter pod 223 connection to the PV pole 210. The inverter pod housing 205 can have a guiding track 331 coupled at its housing's 205 back. The guiding track is configured to guide the inverter housing into position when lowered from above onto the electromechanical support arm 202. A lifting harness/loop 217 shown on top of the inverter pod housing 205 is configured to couple to a lifting cable when lowering the inverter pod hosing 205 into position.

The elements shown include a PV pole 210 section, an inverter pod housing section 205, a lifting harness/loop 217, a flanged bracket 204, and an inverter housing access door 208.

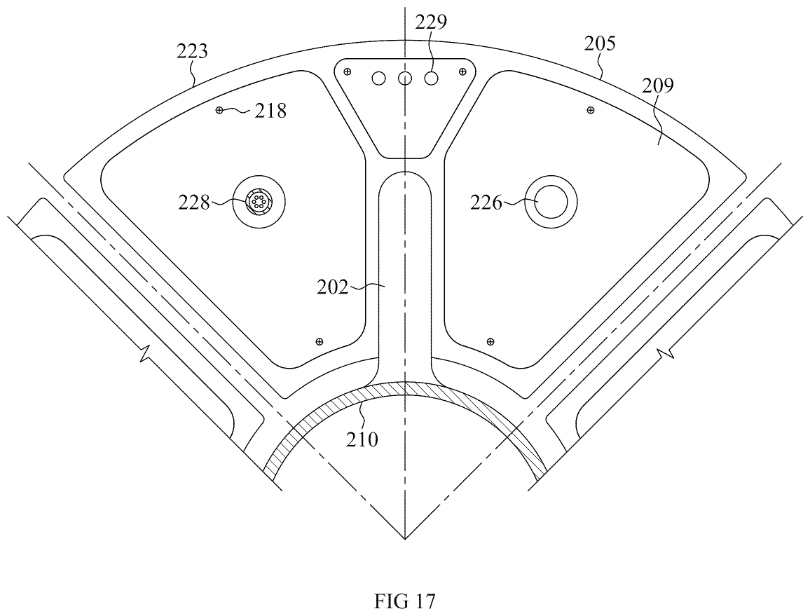

FIG. 17 shows a bottom view of an inverter pod supported by a mechanical arm that is coupled to a PV pole.

The present figure shows a partial horizontal section from a worm-eye view of a PV pole 210 coupled to a mechanical or electromechanical arm 202. The support arm 202 supports, at least in part, the weight of an inverter pod 223. The support arm 202 shown is welded to the exterior wall of the PV pole 210. The mechanical support arm 202 is recessed into the bottom surface of the inverter pod 223. Three device compartments with compartment covers 209 surround the support arm 202. The compartments enable coupling power consuming devices to the bottom surface of the inverter pod 223. The compartment covers 209 can be secured to the inverter pod housing 205 by mechanical fasteners 218 and/or a lock. The elements shown include a PV pole 210, a mechanical support arm 202, a compartment cover 209, an inverter pod 223, an EV plug-in power dispenser cable 228 (in section), a sensing device 226, and an indicator light 229.

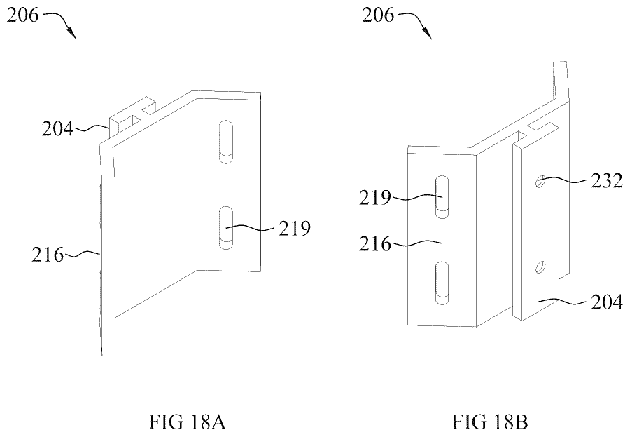

FIGS. 18A and 18B show opposite sides of a flange bracket that is configured to at least maintain the orientation of an inverter pod vertically.

FIG. 18A shows a perspective view of an exemplary flange bracket 206 surface that faces toward a coupled PV pole (not shown). The modular inverter pod (not shown) can be configured for a wide array of uses. Consequently, the vertical height of the inverter pod may vary. For best installation practice, the flange bracket 206 placement against the PV pole exterior surface should be in proximity to the top end of the inverter pod. The precise flange bracket 206 placement on a PV pole is the first step in coupling an inverter pod to a PV pole. The flange bracket/s 206 is/are strapped to the PV pole at a pre-determined height and is/are vertically aligned with mechanical/electromechanical support arm/s (not shown). Then, an inverter pod can be lowered from above, first engaging the flange bracket male leader 204 inside the inverter pod's female guiding track.

The inverter pod can be secured to the male portion of the flange bracket inside the inverter pod housing. Once the inverter pod is in position and secured to the mechanical or electromechanical support arm, bores inside the inverter pod housing are configured to align with corresponding fastening threaded bores 232 in the bracket male leader 204. The bracket strap slots 219 can be sufficiently elongated to avoid strap overlapping when multiple flange brackets 206 are used on a PV pole.

The elements shown include the pole facing side of the guiding track surface 216 and the respective bracket flanges 204 at both vertical sides of the guiding track surface 206. Two strap slots 219 in the bracket flanges 204 enable strapping the bracket flange 204 to the PV pole (not shown).

FIG. 18B shows a perspective view of an exemplary flange bracket 206 surface that faces toward a coupled inverter pod (not shown). The flange bracket 206 can comprise two sub-elements—a surface that includes leader guiding tracks 216 and flanges 204 that are vertically positioned at both sides of the flanged bracket 206. The coupled bracket's flanges 204 flare outward, typically beyond 90° for gripping multidimensional straight or tapered round poles. The flanged bracket 206 can also couple to square or other cross-section pole profiles. Two strap slots 219 shown in a bracket's flange 204 surface are configured to couple the flanged brackets with the inverter pod coupled to a PV pole.

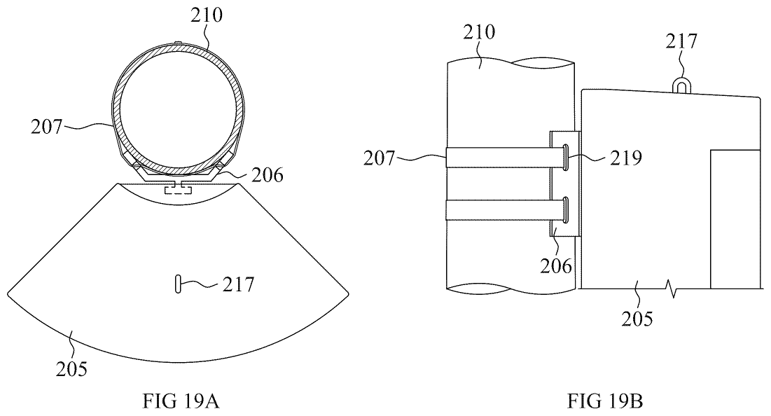

FIGS. 19A and 19B show a partial top and partial side view of a flange bracket coupled to a PV pole respectively. In accordance with the preferred flange bracket 206 embodiment of FIGS. 18A and 18B, the present figures show exemplary diagrams of strapping a flange bracket to a PV pole.

FIG. 19A shows a partial section of a PV pole 210 with a top view of a coupled inverter pod 223. The inverter pod housing 205 is shown coupled to a flange bracket 206. The flanged bracket 206 in turn is shown coupled to the PV pole 210 by strap/s 207. The top surface of the inverter pod housing 205 shows a pod lifting harness/loop 217. The inverter pod is lifted coupled to the lifting harness/loop and is then lowered into position by engaging the pod's housing 205 guiding track 231 in the male guiding track (shown in dashed line) of the flange bracket 204.

FIG. 19B shows a partial elevational view of a PV pole 210 coupled to a flange bracket 206. The flange bracket 206 shown is coupled to a PV pole 210 by two pole straps 207. Two strap slots openings 219 shown in the flange bracket 204 enable the pole straps 207 to couple the inverter pod's housing 205 to the PV pole 210. Where a multi-pod arrangement is used, the height of the flange brackets with their corresponding straps may vary.

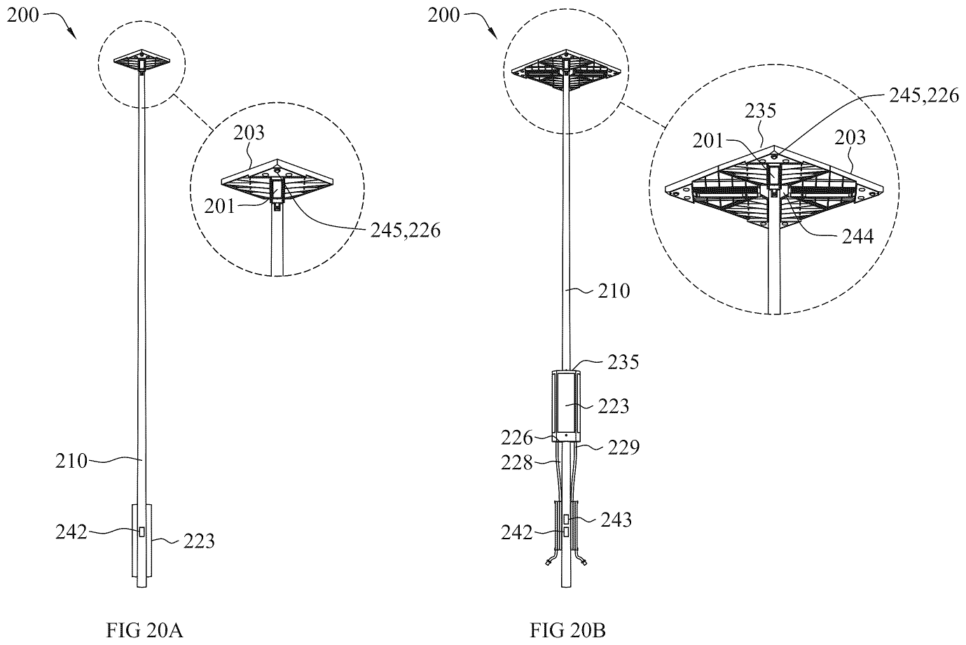

FIGS. 20A and 20B show exemplary PV pole assembly configurations suited for highway and parking lot applications respectively.

FIG. 20A shows a worm-eye view of a PV pole assembly 200 located along a highway. The present figure shows from the top of the PV pole 210 a single light source/luminaire 201 coupled to a pole arm with a PV panel 203 coupled above. At grade, or just above grade an inverter pod 223 is shown coupled to the PV pole 210. The location of the inverter pod 223 can be the opposite side to the side of the luminaire's 201 pole arm with the PV panel coupled 203 from above. There are at least two reasons for the inverter pod 223 placement. First, when the inverter pod 223 is mechanically coupled fully or partially to the PV pole 210, the inverter pod 223 weight can counteract stresses induced on the PV pole 210 from the arm assembly above.

Second, placing the inverter pod 223 away from the roadway side is safer for maintenance staff.

The elements shown include an inverter pod 223, a hand hole cover 242, a PV pole 210, a PV pole arm 244, a light source/luminaire 201, a PV panel 203, a camera 245, a communication antenna 235, and a sensor 226.

FIG. 20B shows a worm-eye view of a PV pole assembly 200 located in an on-grade parking lot. The present figure shows from the top of the PV pole 210 an assembly of four pole arms with each having an integrated light source/luminaire 201 and PV panels 203 coupled above. The figure shows four corresponding inverter pods 223 coupled to the PV pole at 8 ft above grade. At the bottom surface of two of the inverter pods 223, two EV plug-in power cable dispensers 228 are shown with their respective cables resting on pole mounted harnesses. A user interface 243 is shown coupled to the PV pole 210 at user waist height. The user interface 243 can include billing cycle and metering. It is noted that on grade parking structures common to airports and factories can enable substantial power production. Aside from generating power for lighting and EV charging, a portion of the power generated can flow on demand to the manufacturing facility and to the external utility power grid.

The availability of both house power and back-up inverter power on every PV pole 223 introduces welcomed design options. For example, retail stores' on-grade parking lots after business hours are expected to be vacant. It is assumed that occupants of retail parking lots, aside from employee designated parking area, are unwanted. It is also assumed that for energy conservation, circuits conveying power to an off hours parking lot are turned off. The present PV pole assembly 200 coupled to a sensing device 226 can sense the presence of humans, animals, or inert objects in the vicinity of a PV pole 210 and using stored power, can turn on at least one light source/luminaire 201 discouraging the presence of unwanted intruders, alerting security personnel, and/or communicating directly through a PV pole 210 coupled speaker to the intruder/s that their presence is unwanted.

The elements shown include an inverter pod 223, a hand hole cover 242, a user interface 243, an EV plug-in cables dispenser 228, an indicator light 229, a PV pole 210, a PV pole arm 244, a light source/luminaire 201, a PV panel 203, a camera 245, a communication antenna 235, and a sensor 226.

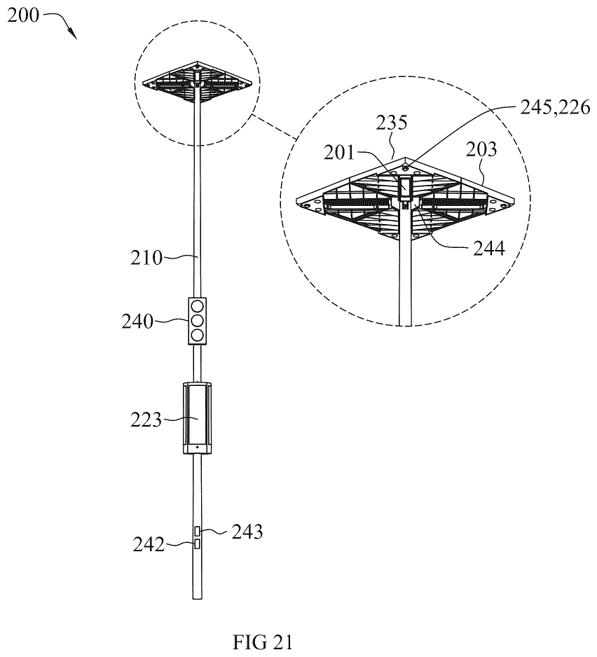

FIG. 21 shows a perspective view of a PV pole assembly configured to include a signaling device. The signaling device 240 coupled to the PV pole 210 is configured to control the mobility of at least vehicle and/or pedestrian in its vicinity. The signaling device 240 is shown coupled to the PV pole 210 above at least one inverter pod 223. Below the inverter pod 223, a human interface 234 is shown at approximately a human's waist height. Below the human interface device, a PV pole hand hole cover 242 is shown. At least one light source/luminaire 201 and a sensing device 226 are shown coupled to the inverter pod 223 bottom surface and another sensing device 223 is shown coupled to the bottom surface of a PV panel 203 above. The sensing devices 226 can be communicatively linked to a processor residing in at least an inverter pod 223 wherein the processor can control the human and vehicle flow below the PV pole 210. For a driver's extended visibility, it is recommended that the inverter pod 223 coupled to a PV pole 210 with a signaling device be at least 8 ft above grade.

The sensing device can be configured to survey human and vehicle presence in the vicinity of the PV pole 210 and/or approaching the vicinity of the PV pole 210. In at least one different embodiment, the same or a different sensing device can be coupled to the PV pole assembly 200 of elements above and/or below the pod. Sensing device/s mounted to the PV pole assembly 200 at higher elevations can extend the survey range capability of a sensing device. The sensing device can employ at least one of heat, sound, chemical, visual, and air pressure detection technology. In at least one embodiment, input received by a sensing device coupled to the PV pole assembly can control a power consuming device coupled to the PV pole assembly 200, and/or a stationary and/or a mobile device in the vicinity of the PV pole assembly 200.

Further, a processor/controller that operates AI code can be configured to operate and control at least one power consuming device coupled to the PV pole assembly 200. The processor can receive input/s from at least one camera that is coupled to the same PV pole assembly 200 and from another sensory or non-sensory device remote. The processor's AI code can autonomously determine in real time at least one of the device/s needing to be controlled, the sequencing of controlling the device/s, and the priorities of activating and deactivating the device/s. The latter is an important feature typically associated with PV pole assembly 200 that has no connectivity to an external power grid. Furthermore, the processor can predictively and preemptively control at least one power consuming device coupled to the PV pole assembly 200 and a remote power consuming device.

A human interface 243 can couple to the PV pole 210. For example, such a device can be a cross-walk button and/or sensor, a voice activated device, a sound emitting device, and a screen displaying alphanumeric text including way finder instruction/s. The human interface 243 device can be coupled to the PV pole 210 at approximately waist height. The human interface device 243 can be coupled to a processor/controller. The processor/controller can be coupled to a plurality of power consuming devices including sensing, power generation, communication, power storage, and output devices.

The processor receiving input/signal from the sensing device in real time can operate by at least one AI code algorithm and can be configured to at least:
a. Prioritize the operation of power consuming devices coupled to the pole assembly based on risk to humans and/or machines,
b. Prioritize the power use of power consuming devices coupled to the pole based on risk assessment to humans and/or machines,
c. Communicate to at least one remote client when at least one power consuming device coupled to the PV pole assembly 200 has failed,
d. Regulate the PV power generated usage dispensing power to at least one power consuming device coupled to the PV pole assembly 200 and to the external power grid.

Upon detecting a failed power consuming device coupled to the PV pole assembly 200, the processor via a communication device can alert at least one remote client. When a failed power consuming device coupled to the PV pole assembly 200 includes an inverter pod with a processor controlling a signaling device, the failed inverter pod module can be configured to be replaced quickly by a replacement inverter pod module. The failed modular inverter pod can then be repaired at the maintenance shop.

It is noted that the modular inverter pod design is configured for quick one for one replacement to minimize traffic disruption that often increases safety risks. The PV pole coupled to at least one signaling device 240 can be powered by at least one external power source and power generated by at least one PV panel 203 coupled to the PV pole 210. The PV pole device's assembly is modular. Further, in at least one embodiment, when external grid power is disrupted, the PV pole 210 coupled to at least one signaling device 240 can operate independently of the external grid power by drawing self-generated power.

The number of PV panels with their corresponding light sources/luminaires can be specified for the specific application as traffic signals typically positioned in urban intersections. The PV pole with a signaling device can be configured for rapid deployment following natural disasters. Configured as a modular system, the PV pole assembly can be erected using a delivered weighted pole base or can be directly embedded in the terrain. It is noted that the present innovation PV pole assembly 200 including a signaling device is especially suited to be used in locations where power is not readily available, and/or is disrupted regularly. It is also noted the present innovation PV pole assembly 200 can be rapidly deployed in locations devastated by a natural disaster or war. In such locations restoring normal vehicular traffic controls can save lives.

Obviously, numerous modifications and variations of the present disclosure are possible in light of the above teachings. It is therefore to be understood that within the scope of the appended claims, the disclosure may be practiced otherwise than as specifically described herein.

### ELEMENT LIST

1. Delta Luminaire
2. Pole
3. Power Storage & Control Unit
4. Inverter
5. PV Devices Enclosure
6. Lock
7. Concrete Base
8. Power Storage & Control Unit Cap
9. Power Storage & Control Unit base
10. Sensing Device
11. Communication Device
12. Processing Device
13. Camera
14. Speaker/Mic
15. Air Quality Sensor
16. Radiation Sensor
17. UAV
18. Rib
19. Elongated Enclosure
20. Frame
21. Lip
22. Power Supply
23. Receptacle
24. Photovoltaic (PV) Panel
25. Light Source
26. Truncated Arm
27. Stiffener
28. Heat Dissipating Fins
29. Electrical Thermal Blanket/Pad
30. Thermal Conductor
31. Mechanical Fastener
32. Lens
33. Through Air Gap
34. Extended Arm
35. Through Air Opening
36. Ground
37. Splice Box Cover
38. Power Supply Cover/Heatsink
39. Device Tray
40. Power/Data Conductor
41. Bore
42. Compartment
43. Power Supply Compartment
44. Sensing Device Compartment
45. Splice Box
46. Battery
47. Power Management Controller
48. PV Sub-panel
49. Power Disconnect
50. Luminaire Housing Structure
51. Heat Reflecting/Non-conductive Pad
52. Fuse
53. Elongated Fastener
54. Photocell
55. Electrical Device
56. Surge Protector
57. Bladeless Fan
58. Compressor
59. Air Pipe
60. Centrifugal Blower
61. Docking Station
62. Homing Device
63. Latching Device
64. Air fan
65. Dust
66. Power Storage/Control Unit Section
67. Enclosure Extender
68. Cabinet Cover/s
69. Cabinet/Shelf
70. Mechanical Key
100. Pole assembly
200. Pole Assembly
201. Light Source/Luminaire
202. Mechanical/Electromechanical Support Arm
203. PV Panel
204. Flange Bracket Male Leader
205. Inverter Pod Housing
206. Flange/d Bracket
207. Pole Strap
208. Access Door
209. Compartment Cover
210. PV Pole
211. Washer
212. Weld
213. Gasket
214. Nut
215. Breather
216. Flange wall/s
217. Lifting Harness/Loop
218. Screw/Fastener
219. Strap Slot
220. Door Lock
221. Shut Off/Switch
222. Electrical Coupler
223. Inverter Pod
224. Battery
225. Conductor
226. Sensing Device
227. Processor
228. EV Plug-in Cable Dispenser
229. Indicator Light
230. Communication Device
231. Pod Female Guiding Track
232. Fastening Threaded Bore
233. PV Panel Arm
234. Crosswalk Button
235. Antenna
236. Entry Bore/Opening
237. Door Frame
238. Electro/Mechanical Support Arm Recess
239. Coupler Opening
240. Traffic Light Signal
241. Receptacle
242. Hand Hole Cover
243. User Interface/Crosswalk Button
244. Pole Arm
245. A Camera

1. A self-powered pole assembly, comprising:
a pole structure having a top end and a grade-level base end;
an arm mechanically attachable to the pole structure proximate the top end;
a luminaire mechanically integrated with the arm;
a photovoltaic (PV) panel mechanically coupled from above to the arm, wherein
the PV panel is positioned on the arm with two opposing corners of the PV panel aligned with the arm,
the PV panel is substantially square,
the PV panel extends outwardly from opposing sides of the arm, and the PV panel and the arm are scalable in size, and
the luminaire, and the PV panel comprise at least one long-lived device;
at least one inverter pod coupled to the pole structure at a position at or below two-thirds of a height of the pole structure from grade, wherein the at least one inverter pod has a vertical longitudinal axis substantially parallel to a vertical longitudinal axis of the pole structure,
the at least one inverter pod houses at least one short-lived electrical device which is at least one an inverter, a power storage device, a surge suppressor, a shutoff switch, a computer processor, a communication device, a sensing device, a power output device, a receptacle, a metering device, and an indicator light source; and
at least one conductor configured to convey power between the PV panel and the at least one short-lived electrical device housed in the at least one inverter pod.

2. The self-powered pole assembly of claim 1, wherein the at least one inverter pod comprises a housing and an access door, and the access door is positioned on a side of the housing facing away from the pole structure.

3. The self-powered pole assembly of claim 1, wherein the at least one inverter pod further comprises at least one air breather configured to permit airflow into the inverter pod, out of the inverter pod, or in and out of the inverter pod.

4. The self-powered pole assembly of claim 1, wherein the at least one inverter pod further comprises a lifting harness.

5. The self-powered pole assembly of claim 1, wherein the at least one inverter pod further comprises a housing, an access door, and at least one lock configured to secure the access door to the housing.

6. The self-powered pole assembly of claim 1, further comprising a mechanical or an electromechanical support arm coupled to the pole structure, wherein the at least one inverter pod is mounted on and supported by the support arm.

7. The self-powered pole assembly of claim 1, further comprising at least one guiding track coupled to the pole structure, the at least one guiding track being configured to engage a corresponding feature on the at least one inverter pod to maintain vertical alignment with the pole structure.

8. A self-powered pole assembly, comprising:
a pole structure having a top end and a grade-level base end;
an arm mechanically attachable to the pole structure proximate the top end;
a luminaire mechanically integrated with the arm;
a photovoltaic (PV) panel mechanically coupled from above to the arm, wherein
the PV panel is positioned on the arm with two opposing corners of the PV panel aligned with the arm,
the PV panel is substantially square, and
the PV panel extends outwardly from opposing sides of the arm;
at least one pod coupled to the pole structure below the arm, the at least one pod houses a computer processor, and at least one electrical device that includes at least one of an inverter, a power storage device, a surge suppressor, a shutoff switch, a sensor, a communication device, a power output device, a receptacle, a metering device, and an indicator light source, wherein power generated by the PV panel is conveyed to the at least one pod through a power entry on a bottom surface, a side surface, or both, of the at least one pod; and
at least one power consuming device coupled to the pole assembly and electrically coupled to the at least one pod, wherein
the computer processor is configured to activate or deactivate the at least one power consuming device in response to at least one of a sensor signal indicating a presence of an object in a vicinity of the pole structure, a signal from a physical external engagement, or a wireless communication signal.

9. The self-powered pole assembly of claim 8, wherein the at least one electrical device includes the sensor, the sensor being at least one of an occupancy sensor or a camera.

10. The self-powered pole assembly of claim 8, wherein the computer processor is further configured to execute at least one artificial intelligence (AI) algorithm.

11. The self-powered pole assembly of claim 8, wherein the at least one electrical device includes the power storage device, the at least one power consuming device is the luminaire, and the computer processor is configured to activate the luminaire in response to the sensor signal by drawing power from the power storage device when an external power grid source is unavailable.

12. The self-powered pole assembly of claim 8, wherein the at least one electrical device includes the communication device, and the communication device is configured to convey signals between the computer processor and at least one of another pole assembly or a remote client.

13. The self-powered pole assembly of claim 8, further comprising a speaker coupled to the pole assembly and in communication with the computer processor, wherein the computer processor is further configured to cause the speaker to announce an alert.

14. The self-powered pole assembly of claim 8, wherein the at least one pod comprises a first pod and an adjacent second pod, and wherein the first pod is electrically coupled to the second pod to communicatively distribute an operational function between the first pod and the second pod.

15. A self-powered pole assembly, comprising:
a pole structure having a top end and a grade-level base end;
an arm mechanically attachable to the pole structure proximate the top end;
a luminaire mechanically integrated with the arm;
a photovoltaic (PV) panel mechanically coupled from above to the arm, wherein
the PV panel is positioned on the arm with two opposing corners of the PV panel aligned with the arm,
the PV panel is substantially square, and
the PV panel extends outwardly from opposing sides of the arm;
at least one inverter pod coupled to the pole structure below the arm, wherein the at least one inverter pod has a vertical longitudinal axis substantially parallel to a vertical longitudinal axis of the pole structure, and wherein the at least one inverter pod houses a computer processor, a communication device, and a power storage device;
at least one conductor configured to convey power between the PV panel and the at least one inverter pod; and
a signaling device mechanically coupled to the pole structure and electrically coupled to the at least one inverter pod, wherein
the computer processor is configured to
receive an input signal and generate an output signal for transmission by the communication device to at least one of another device on the pole assembly, a mobile device, or a remote client, and
upon detection of a disruption in an external power supply, power the signaling device using power generated by the PV panel or power stored in the power storage device.

16. The self-powered pole assembly of claim 15, further comprising a user interface coupled to the pole structure and in communication with the computer processor.

17. The self-powered pole assembly of claim 15, further comprising a sensor coupled to the pole assembly and in communication with the computer processor.

18. The self-powered pole assembly of claim 15, wherein the computer processor is further configured to execute artificial intelligence (AI) code to prioritize operation of power consuming devices coupled to the pole assembly based on risk to humans or machines, prioritize power use of the power consuming devices based on risk assessments, communicate a failure of at least one power consuming device to at least one remote client via the communication device, and regulate power generated by the PV panel to dispense the power to at least one power consuming device coupled to the pole assembly or to an external power grid.

19. The self-powered pole assembly of claim 15, wherein the computer processor is further configured to, upon detecting a failure of a power consuming device coupled to the pole assembly, cause the communication device to transmit an alert to at least one remote client.

20. The self-powered pole assembly of claim 15, wherein the at least one inverter pod is a modular unit configured to be removed from and installed on the pole structure via a quick-connect electrical and mechanical interface.

21. A method of coupling a pod to a pole, the pole having a support arm, the method comprising:
securing a flange bracket having a guiding track to the pole with a strap at a position above the support arm;
lifting the pod via a lifting harness coupled to the pod;
engaging a corresponding track on the pod with the guiding track on the flange bracket;
lowering the pod along the guiding track until the pod rests on the support arm;
removing an access door from the pod;
mechanically securing the pod to the flange bracket;
electrically engaging a wiring harness from an interior of the pod with a receptacle associated with the support arm; actuating a test switch to verify operation; and
securing the access door to a housing of the pod.
